(19) United States
(12) Patent Application Publication
(10) Pub. No.: US 2020/0217057 A1
(43) Pub. Date: Jul. 9, 2020

(54) Self-cleaning Public Bathroom Systems and Methods

(71) Applicant: First Star Communications Ltd., Wellington (NZ)

(72) Inventors: Kevin Spiro, Squamish (CA); Adam Blackwell, Wellington (NZ)

(73) Assignee: First Star Communications Ltd., Wellington (NZ)

(21) Appl. No.: 16/736,650

(22) Filed: Jan. 7, 2020

Related U.S. Application Data
(60) Provisional application No. 62/789,336, filed on Jan. 7, 2019.

(51) Int. Cl. E03D 9/00; B25J 11/00; G06F 3/01; G08B 21/22; A47L 11/40; A47L 11/28; B08B 1/00; A47L 9/00; A47L 9/28; E05F 15/00

(52) U.S. Cl. CPC E03D 9/002; A47L 2201/06; G06F 3/017; G08B 21/22; A47L 11/4011; A47L 11/28; B08B 1/001; A47L 11/4091; A47L 11/4005; A47L 9/0063; A47L 9/2847; A47L 9/2852; E05F 15/00; A47L 2201/04; A47L 2201/022; B25J 11/0085

(57) ABSTRACT

Apparatus and associated methods relate to an autonomous modular bathroom facility configured to detect a bathroom user exited the bathroom, determine no user remains in the bathroom, lock the door, and automatically clean the bathroom. In an illustrative example, automatic cleaning may be triggered in response to detecting a user unlocked and exited the bathroom. The bathroom facility may lock the door and initiate the cleaning process based on determining the bathroom is not occupied. For example, some embodiments may determine the bathroom is unoccupied when a user exits the bathroom without another entering, based on bathroom occupancy determined as a function of a sensor. The sensor may include, for example, one or more weight, movement, heat, or other type sensor. The door may be locked when the bathroom is unoccupied, for example, permitting the bathroom to be safely cleaned. Various embodiment autonomous modular bathroom facilities may include hardware appliance components adapted to perform parts of an exemplary cleaning process. In some embodiment implementations, each appliance may be configured with a controller governing the appliance operation. In a preferred embodiment, software connects the hardware components of the cleaning process together in a specific way with a central online information hub, to facilitate the cleaning process. Various examples may advantageously improve bathroom cleanliness with reduced effort, based on safely and automatically cleaning the bathroom on demand.

### CROSS-REFERENCE TO RELATED APPLICATIONS

This application claims the benefit of U.S. Provisional Application No. 62/789,336, titled “Self-cleaning Public Bathroom Systems and Methods,” Inventors: Kevin Spiro and Adam Blackwell, filed by Applicants: Kevin Spiro and Adam Blackwell, on Jan. 7, 2019.

This application incorporates the entire contents of the above-referenced application herein by reference.

### TECHNICAL FIELD

Various embodiments relate generally to autonomous self-cleaning bathrooms.

### BACKGROUND

Public bathrooms are a useful convenience. Some businesses provide bathrooms for their customers or the public. All bathrooms need regular cleaning and maintenance. Public use bathroom facilities require frequent cleaning and supply replenishment. In some scenarios, the maintenance and cleaning of a public access bathroom facility may become a burden to a business.

### SUMMARY

Apparatus and associated methods relate to an autonomous modular bathroom facility configured to detect a bathroom user exited the bathroom, determine no user remains in the bathroom, lock the door, and automatically clean the bathroom. In an illustrative example, automatic cleaning may be triggered in response to detecting a user unlocked and exited the bathroom. The bathroom facility may lock the door and initiate the cleaning process based on determining the bathroom is not occupied. For example, some embodiments may determine the bathroom is unoccupied when a user exits the bathroom without another entering, based on bathroom occupancy determined as a function of a sensor. The sensor may include, for example, one or more weight, movement, heat, or other type sensor. The door may be locked when the bathroom is unoccupied, for example, permitting the bathroom to be safely cleaned. Various embodiment autonomous modular bathroom facilities may include hardware appliance components adapted to perform parts of an exemplary cleaning process. In some embodiment implementations, each appliance may be configured with a controller governing the appliance operation. In a preferred embodiment, software connects the hardware components of the cleaning process together in a specific way with a central online information hub, to facilitate the cleaning process. Various examples may advantageously improve bathroom cleanliness with reduced effort, based on safely and automatically cleaning the bathroom on demand.

Various embodiments may achieve one or more advantages. For example, some embodiments may improve bathroom cleanliness. Such improved bathroom cleanliness may be a result of providing a bathroom facility configured to automatically self-clean after each bathroom use. Some embodiments may increase the availability of clean bathroom facilities. Such increased clean bathroom availability may be a result of providing a bathroom that cleans itself, reducing the facility owner's effort maintaining bathroom cleanliness. Various embodiments may improve bathroom cleanliness through automatic self-cleaning while maintaining bathroom user safety and privacy. This facilitation may be a result of a self-cleaning process that only begins when a user exits the bathroom, with no other user in the bathroom. In an illustrative example, the cleaning process of some embodiments may only begin when a user has exited, and sensor input indicates no other user has entered the bathroom. Various implementations may improve the user's experience with automatic self-cleaning. This facilitation may be a result of reducing the user's effort determining if it is safe to enter the bathroom based on timing the bathroom self-cleaning cycle. Such reduced user effort determining when it will be safe to enter a self-cleaning bathroom may be a result of providing a self-cleaning bathroom that locks the door after the last user has exited, before beginning the cleaning process.

Some embodiments may enhance the sense of security of a self-cleaning bathroom user. Such enhanced user sense of security may be a result of providing a self-cleaning bathroom with a self-locking door that may be unlocked using a code from a mobile app, or from the inside using a touch free sensor to open the door, or by pushing the door open. Some embodiments may reduce the distribution of disease germs among public bathroom users. Such reduced disease germ distribution may be a result of a self-cleaning bathroom configured for hands-free use. In an illustrative example, a user may wave a hand across a sensor to unlock the door and enter the bathroom. In some embodiments, the sink, soap, or hand dryer may be activated using motion sensors. Various implementations may include a toilet configured to automatically flush when a user moves away from the toilet. In some embodiments, a self-cleaning bathroom may reduce the bathroom operator's effort maintaining clean bathroom floors. This facilitation may be a result of an autonomous floor cleaning robot configured to clean the entire floor, or spot clean areas determined by sensors to require cleaning, and self-charge between cleaning cycles. Various designs may improve a bathroom operator's knowledge of the bathroom status. Such improved bathroom status knowledge may be a result of a self-cleaning bathroom configured to collect bathroom facility operational data, including usage, cleaning cycle, and supply inventory levels, and send the operational data to a central online information hub.

The details of various embodiments are set forth in the accompanying drawings and the description below. Other features and advantages will be apparent from the description and drawings, and from the claims.

### BRIEF DESCRIPTION OF THE DRAWINGS

FIG. 1 depicts an illustrative operational scenario wherein a user employs an exemplary autonomous modular bathroom facility configured to detect a bathroom user exiting the bathroom, determine no user remains in the bathroom, lock the door, and automatically clean the bathroom.

FIG. 2 depicts a schematic view of an exemplary autonomous modular bathroom facility network configured to collect and send to a central online information hub bathroom facility operational data.

FIG. 3 depicts a structural view of an exemplary autonomous modular bathroom facility controller.

FIG. 4 depicts an illustrative schematic view of an exemplary computing device, in accordance with at least some exemplary embodiments of the present disclosure.

FIG. 5 depicts an exemplary process flow of an embodiment autonomous modular bathroom facility cleaning method.

FIG. 6 depicts an exemplary process flow of an embodiment autonomous modular bathroom facility door lock/unlock method.

FIGS. 7A-7B together depict an exemplary process flow of an embodiment autonomous modular bathroom facility cleaning method.

FIG. 8 depicts an exemplary process flow of an embodiment autonomous modular bathroom facility in-use method.

Like reference symbols in the various drawings indicate like elements.

### DETAILED DESCRIPTION OF ILLUSTRATIVE EMBODIMENTS

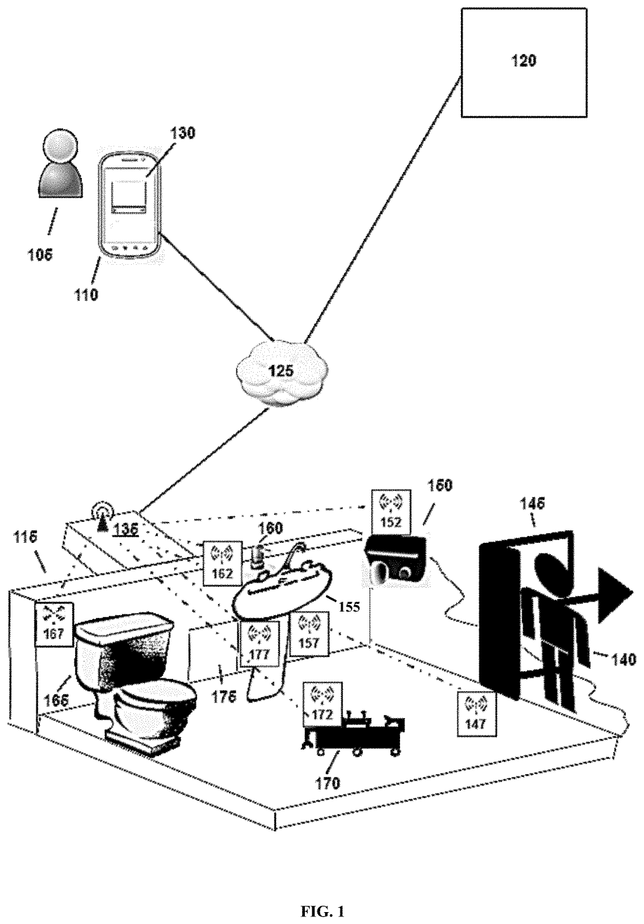

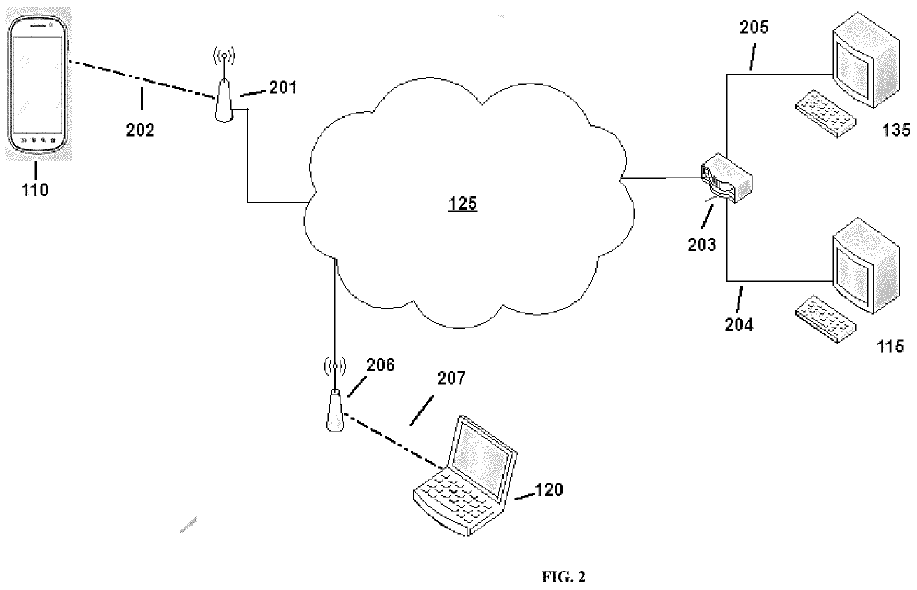

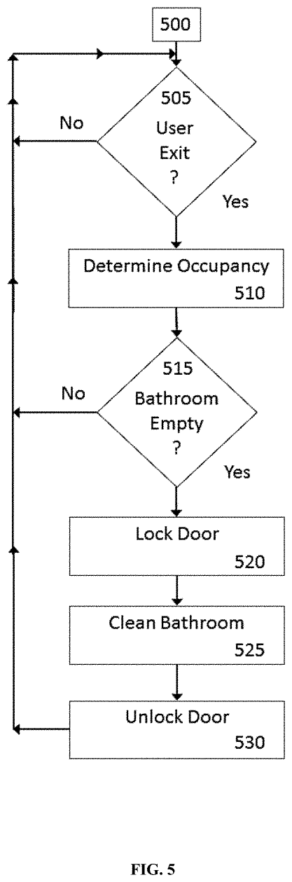

To aid understanding, this document is organized as follows. First, an example operational scenario illustrative of an exemplary autonomous modular bathroom facility configured to detect a bathroom user exiting the bathroom, determine no user remains in the bathroom, lock the door, and automatically clean the bathroom, is briefly introduced with reference to FIG. 1. Then, with reference to FIGS. 2-4, the discussion turns to exemplary embodiments that illustrate autonomous self-cleaning bathroom design. Specifically, exemplary autonomous modular bathroom facility network, facility controller, and appliance controller embodiment designs are disclosed. Finally, with reference to FIGS. 5-8, illustrative process flows exemplary of embodiment autonomous modular bathroom facility cleaning, lock/unlock, and in-use methods are disclosed, to explain improvements in autonomous self-cleaning bathroom technology.

FIG. 1 depicts an illustrative operational scenario wherein a user employs an exemplary autonomous modular bathroom facility configured to detect a bathroom user exiting the bathroom, determine no user remains in the bathroom, lock the door, and automatically clean the bathroom by an autonomous intelligent cleaning process completed within a short period of time, for example within thirty seconds. In FIG. 1, the user 105 employs the illustrative mobile computing device 110 to monitor and control the exemplary autonomous modular bathroom facility 115 using the illustrative central online information hub 120. In the example depicted by FIG. 1, the mobile computing device 110, the autonomous modular bathroom facility 115, and the exemplary central online information hub 120 are together communicatively and operably coupled to each other via the exemplary network cloud 125. In the illustrated example, the user 105 employs the mobile app 130 configured in the mobile computing device 110 to monitor and control the autonomous modular bathroom facility 115 operation and maintenance governed by the bathroom facility controller 135. In the example depicted by FIG. 1, the autonomous modular bathroom facility 115 includes the bathroom facility controller 135 communicatively and operatively coupled with the bathroom facility 115 appliances via wireless communication links. In the illustrated example, the bathroom facility controller 135 is configured to govern the operation of the bathroom facility 115 appliances in collaboration with the central online information hub 120. In various embodiments, each bathroom facility 115 appliance may be configured with a controller adapted to operate the appliance, communicate status, receive operational commands, and acknowledge the execution of operational commands. In some embodiments, each appliance controller may collaborate with the bathroom facility controller 135 or mobile app 130 to implement a bathroom facility 115 process or function. In the depicted embodiment, the bathroom user 140 is detected exiting the bathroom facility 115 through the door 145 by the door controller 147 operably coupled with the door 145. In the illustrated embodiment, the door controller 147 includes controls operable to govern opening, closing, locking, and unlocking the door 145. In the depicted embodiment, the door controller 147 includes a floor weight sensor, or motion sensor, or heat sensor, or other sensor, adapted to indicate the presence of a user in the bathroom facility 115. In various embodiments, the door controller 147 may include one or more thermal, weight, or motion sensor adapted to indicate the presence of a user in the bathroom facility 115. In the illustrated example, the bathroom facility 115 provided the user 140 with an automated hands-free sensor-driven usage experience. In the depicted embodiment, the user can use the dryer, water, and obtain soap by motion sensors, without the user having to touch the appliances. For example, the air dryer 150 pumped out hot air for a period of time governed by the air dryer controller 152, after detecting by motion sensor the user 140 washed their hands using the sink 155. In the depicted embodiment, based on motion sensors, the sink controller 157 operated the sink 155 to run warm water, and the soap dispenser 160 dispensed a predetermined amount of soap, governed by the soap dispenser controller 162, to facilitate the user 140 hand washing, hand-touch-free and on demand triggered by motion sensors. In the depicted example, the bathroom facility 115 determines no one is in the bathroom after the user 140 exited, and locks the door 145 via the door controller 147. In the illustrated embodiment, the toilet 165 is automatically flushed by the toilet controller 167. In various examples, the toilet 165 seat and bowl may be cleaned and disinfected by the toilet controller 167. In the illustrated example, the cleaning robot 170 cleans the floor as directed by the cleaning robot controller 172, using vacuum and mop with anti-slip cleaning solution. After cleaning the floor, the cleaning robot 170 stores itself in the cleaning robot storage compartment 175 governed by the cleaning robot storage compartment controller 177. In the depicted embodiment, the cleaning robot storage compartment 175 includes a door operable to secure the cleaning robot 170 from theft or vandalism. In the illustrated embodiment, the cleaning robot storage compartment 175 also includes a charging pad configured to charge the cleaning robot 170 between cleans.

FIG. 2 depicts a schematic view of an exemplary autonomous modular bathroom facility network configured to collect and send to a central online information hub bathroom facility operational data. In FIG. 2, according to an exemplary embodiment of the present disclosure, data may be transferred to the system, stored by the system and/or transferred by the system to users of the system across local area networks (LANs) or wide area networks (WANs). In accordance with various embodiments, the system may include numerous servers, data mining hardware, computing devices, or any combination thereof, communicatively connected across one or more LANs and/or WANs. One of ordinary skill in the art would appreciate that there are numerous manners in which the system could be configured, and embodiments of the present disclosure are contemplated for use with any configuration. Referring to FIG. 2, a schematic overview of a system in accordance with an embodiment of the present disclosure is shown. In the depicted embodiment, an exemplary system includes the exemplary mobile computing device 110 configured to monitor the autonomous modular bathroom facility 115 operation and maintenance governed by the central online information hub 120 and the bathroom facility controller 135. In the depicted example, the mobile computing device 110 is a smartphone configured with a mobile app adapted to control and monitor the bathroom facility 115. In the illustrated example, the bathroom facility 115 includes a computer-implemented bathroom module interface configured to govern electrical power, water, sewer, communications, security, and other utility services in the bathroom facility 115 in collaboration with the central online information hub 120 and the bathroom facility controller 135. In the depicted example, the central online information hub 120 is a cloud server configured to monitor the bathroom facility operation via status, notifications, supply levels, and alerts in collaboration with the bathroom facility controller 135 and the mobile computing device 110 mobile app. In the illustrated embodiment, the mobile computing device 110 is communicatively and operably coupled by the wireless access point 201 and the wireless link 202 with the network cloud 125 (e.g., the Internet) to send, retrieve, or manipulate information in storage devices, servers, and network components, and exchange information with various other systems and devices via the network cloud 125. In the depicted example, the illustrative system includes the router 203 configured to communicatively and operably couple the autonomous modular bathroom facility 115 to the network cloud 125 via the communication link 204. In the illustrated example, the router 203 also communicatively and operably couples the bathroom facility 115 controller 135 to the network cloud 125 via the communication link 205. In the depicted embodiment, the central online information hub 120 is communicatively and operably coupled with the network cloud 125 by the wireless access point 206 and the wireless communication link 207. In various examples, one or more of: the mobile computing device 110, autonomous modular bathroom facility 115, central online information hub 120, or bathroom facility controller 135 may include an application server configured to store or provide access to information used by the system. In various embodiments, one or more application server may retrieve or manipulate information in storage devices and exchange information through the network cloud 125. In some examples, one or more of: the mobile computing device 110, autonomous modular bathroom facility 115, central online information hub 120, or bathroom facility controller 135 may include various applications implemented as processor-executable program instructions. In some embodiments, various processor-executable program instruction applications may also be used to manipulate information stored remotely and process and analyze data stored remotely across the network cloud 125 (for example, the Internet). According to an exemplary embodiment, as shown in FIG. 2, exchange of information through the network cloud 125 or other network may occur through one or more high speed connections. In some cases, high speed connections may be over-the-air (OTA), passed through networked systems, directly connected to one or more network cloud 125 or directed through one or more router. In various implementations, one or more router may be optional, and other embodiments in accordance with the present disclosure may or may not utilize one or more router. One of ordinary skill in the art would appreciate that there are numerous ways any or all of the depicted devices may connect with the network cloud 125 for the exchange of information, and embodiments of the present disclosure are contemplated for use with any method for connecting to networks for the purpose of exchanging information. Further, while this application may refer to high speed connections, embodiments of the present disclosure may be utilized with connections of any useful speed. In an illustrative example, components or modules of the system may connect to one or more of: the mobile computing device 110, autonomous modular bathroom facility 115, central online information hub 120, or bathroom facility controller 135 via the network cloud 125 or other network in numerous ways. For instance, a component or module may connect to the system i) through a computing device directly connected to the network cloud 125, ii) through a computing device connected to the network cloud 125 through a routing device, or iii) through a computing device connected to a wireless access point. One of ordinary skill in the art will appreciate that there are numerous ways that a component or module may connect to a device via network cloud 125 or other network, and embodiments of the present disclosure are contemplated for use with any network connection method. In various examples, one or more of: the mobile computing device 110, autonomous modular bathroom facility 115, central online information hub 120, or bathroom facility controller 135 could include a personal computing device, such as a smartphone, tablet computer, wearable computing device, cloud-based computing device, virtual computing device, or desktop computing device, configured to operate as a host for other computing devices to connect to. In some examples, one or more communications means of the system may be any circuitry or other means for communicating data over one or more networks or to one or more peripheral devices attached to the system, or to a system module or component. Appropriate communications means may include, but are not limited to, wireless connections, wired connections, cellular connections, data port connections, Bluetooth® connections, near field communications (NFC) connections, or any combination thereof. One of ordinary skill in the art will appreciate that there are numerous communications means that may be utilized with embodiments of the present disclosure, and embodiments of the present disclosure are contemplated for use with any communications means.

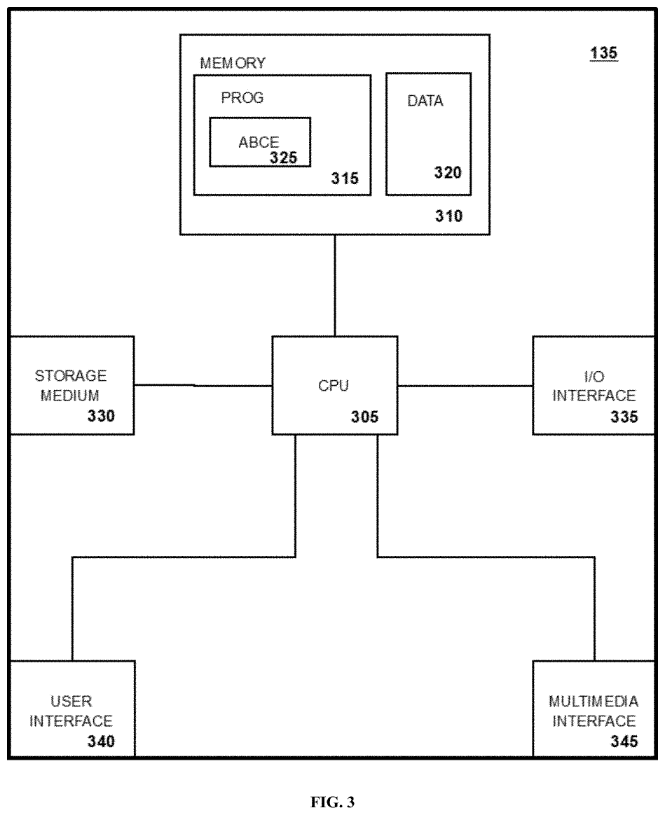

FIG. 3 depicts a structural view of an exemplary autonomous modular bathroom facility controller. In FIG. 3, the block diagram of the exemplary bathroom facility controller 135 includes processor 305 and memory 310. The processor 305 is in electrical communication with the memory 310. The depicted memory 310 includes program memory 315 and data memory 320. The depicted program memory 315 includes processor-executable program instructions implementing the ABCE (Autonomous Bathroom Cleaning Engine) 325. In some embodiments, the illustrated program memory 315 may include processor-executable program instructions configured to implement an OS (Operating System). In various embodiments, the OS may include processor executable program instructions configured to implement various operations when executed by the processor 305. In some embodiments, the OS may be omitted. In some embodiments, the illustrated program memory 315 may include processor-executable program instructions configured to implement various Application Software. In various embodiments, the Application Software may include processor executable program instructions configured to implement various operations when executed by the processor 305. In some embodiments, the Application Software may be omitted. In the depicted embodiment, the processor 305 is communicatively and operably coupled with the storage medium 330. In the depicted embodiment, the processor 305 is communicatively and operably coupled with the I/O (Input/Output) interface 335. In the depicted embodiment, the I/O interface 335 includes a network interface. In various implementations, the network interface may be a wireless network interface. In some designs, the network interface may be a Wi-Fi interface. In some embodiments, the network interface may be a Bluetooth interface. In an illustrative example, the bathroom facility controller 135 may include more than one network interface. In some designs, the network interface may be a wireline interface. In some designs, the network interface may be omitted. In the depicted embodiment, the processor 305 is communicatively and operably coupled with the user interface 340. In various implementations, the user interface 340 may be adapted to receive input from a user or send output to a user. In some embodiments, the user interface 340 may be adapted to an input-only or output-only user interface mode. In various implementations, the user interface 340 may include an imaging display. In some embodiments, the user interface 340 may include an audio interface. In some designs, the audio interface may include an audio input. In various designs, the audio interface may include an audio output. In some implementations, the user interface 340 may be touch-sensitive. In some designs, the bathroom facility controller 135 may include an accelerometer operably coupled with the processor 305. In various embodiments, the bathroom facility controller 135 may include a GPS module operably coupled with the processor 305. In an illustrative example, the bathroom facility controller 135 may include a magnetometer operably coupled with the processor 305. In some embodiments, the user interface 340 may include an input sensor array. In various implementations, the input sensor array may include one or more imaging sensor. In various designs, the input sensor array may include one or more audio transducer. In some implementations, the input sensor array may include a radio-frequency detector. In an illustrative example, the input sensor array may include an ultrasonic audio transducer. In some embodiments, the input sensor array may include image sensing subsystems or modules configurable by the processor 305 to be adapted to provide image input capability, image output capability, image sampling, spectral image analysis, correlation, autocorrelation, Fourier transforms, image buffering, image filtering operations including adjusting frequency response and attenuation characteristics of spatial domain and frequency domain filters, image recognition, pattern recognition, or anomaly detection. In various implementations, the depicted memory 310 may contain processor executable program instruction modules configurable by the processor 305 to be adapted to provide image input capability, image output capability, image sampling, spectral image analysis, correlation, autocorrelation, Fourier transforms, image buffering, image filtering operations including adjusting frequency response and attenuation characteristics of spatial domain and frequency domain filters, image recognition, pattern recognition, or anomaly detection. In some embodiments, the input sensor array may include audio sensing subsystems or modules configurable by the processor 305 to be adapted to provide audio input capability, audio output capability, audio sampling, spectral audio analysis, correlation, autocorrelation, Fourier transforms, audio buffering, audio filtering operations including adjusting frequency response and attenuation characteristics of temporal domain and frequency domain filters, audio pattern recognition, or anomaly detection. In various implementations, the depicted memory 310 may contain processor executable program instruction modules configurable by the processor 305 to be adapted to provide audio input capability, audio output capability, audio sampling, spectral audio analysis, correlation, autocorrelation, Fourier transforms, audio buffering, audio filtering operations including adjusting frequency response and attenuation characteristics of temporal domain and frequency domain filters, audio pattern recognition, or anomaly detection. In the depicted embodiment, the processor 305 is communicatively and operably coupled with the multimedia interface 345. In the illustrated embodiment, the multimedia interface 345 includes interfaces adapted to input and output of audio, video, and image data. In some embodiments, the multimedia interface 345 may include one or more still image camera or video camera. In various designs, the multimedia interface 345 may include one or more microphone. In some implementations, the multimedia interface 345 may include a wireless communication means configured to operably and communicatively couple the multimedia interface 345 with a multimedia data source or sink external to the bathroom facility controller 135. In various designs, the multimedia interface 345 may include interfaces adapted to send, receive, or process encoded audio or video. In various embodiments, the multimedia interface 345 may include one or more video, image, or audio encoder. In various designs, the multimedia interface 345 may include one or more video, image, or audio decoder. In various implementations, the multimedia interface 345 may include interfaces adapted to send, receive, or process one or more multimedia stream. In various implementations, the multimedia interface 345 may include a GPU. In some embodiments, the multimedia interface 345 may be omitted. Useful examples of the illustrated bathroom facility controller 135 include, but are not limited to, personal computers, servers, tablet PCs, smartphones, or other computing devices. In some embodiments, multiple bathroom facility controller 135 devices may be operably linked to form a computer network in a manner as to distribute and share one or more resources, such as clustered computing devices and server banks/farms. Various examples of such general-purpose multi-unit computer networks suitable for embodiments of the disclosure, their typical configuration and many standardized communication links are well known to one skilled in the art, as explained in more detail in the foregoing FIG. 2 description. In some embodiments, an exemplary bathroom facility controller 135 design may be realized in a distributed implementation. In an illustrative example, some bathroom facility controller 135 designs may be partitioned between a client device, such as, for example, a phone, and, a more powerful server system, as depicted, for example, in FIG. 2. In various designs, a bathroom facility controller 135 partition hosted on a PC or mobile device may choose to delegate some parts of computation, such as, for example, machine learning or deep learning, to a host server. In some embodiments, a client device partition may delegate computation-intensive tasks to a host server to take advantage of a more powerful processor, or to offload excess work. In an illustrative example, some devices may be configured with a mobile chip including an engine adapted to implement specialized processing, such as, for example, neural networks, machine learning, artificial intelligence, image recognition, audio processing, or digital signal processing. In some embodiments, such an engine adapted to specialized processing may have sufficient processing power to implement some features. However, in some embodiments, an exemplary bathroom facility controller 135 may be configured to operate on a device with less processing power, such as, for example, various gaming consoles, which may not have sufficient processor power, or a suitable CPU architecture, to adequately support bathroom facility controller 135. Various embodiment designs configured to operate on a such a device with reduced processor power may work in conjunction with a more powerful server system.

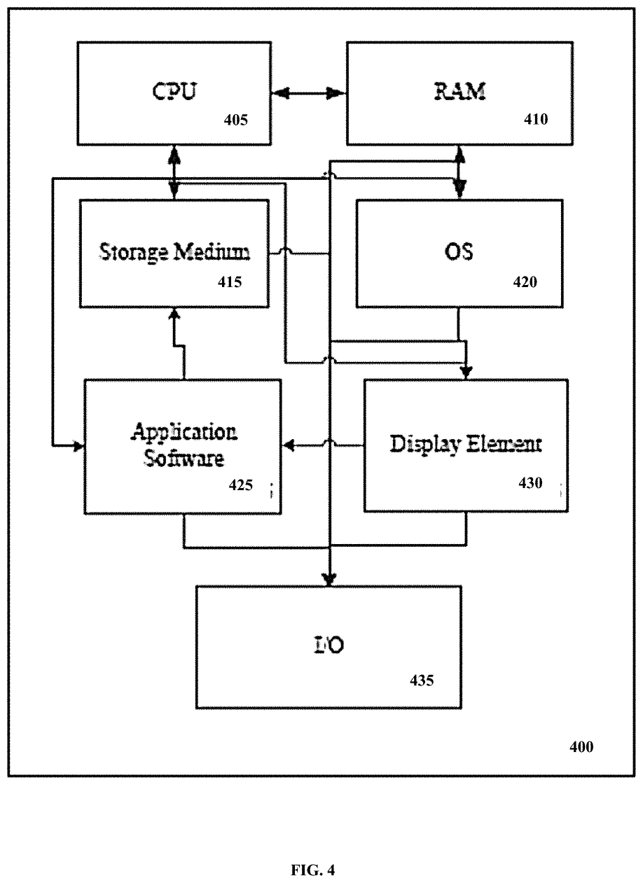

FIG. 4 depicts an illustrative schematic view of an exemplary computing device, in accordance with at least some exemplary embodiments of the present disclosure. With reference to FIG. 4, an illustrative representation of a computing device appropriate for use with some embodiments of the system of the present disclosure is described. The exemplary computing device 400 can generally be comprised of a Central Processing Unit (CPU, 405), optional further processing units including a graphics processing unit (GPU), a Random Access Memory (RAM, 410), a mother board 415, or alternatively/additionally a storage medium (e.g., hard disk drive, solid state drive, flash memory, cloud storage), an operating system (OS, 420), one or more application software 425, a display element 430, and one or more input/output devices/means 435, including one or more communication interfaces (e.g., RS232, Ethernet, Wifi, Bluetooth, USB). Useful examples include, but are not limited to, personal computers, smart phones, laptops, mobile computing devices, tablet PCs, and servers. Multiple computing devices can be operably linked to form a computer network in a manner as to distribute and share one or more resources, such as clustered computing devices and server banks/farms.

Various examples of such general-purpose multi-unit computer networks suitable for embodiments of the disclosure, their typical configuration and many standardized communication links are well known to one skilled in the art, as explained in more detail and illustrated by FIG. 2.

For example, the exemplary appliance controllers disclosed with reference to FIG. 1 may each be realized as a computer-implemented bathroom subsystem module configured to execute a bathroom cleaning process in response to receiving a bathroom cleaning process activation command, in accordance with the exemplary computing device 400 depicted by FIG. 4. In various embodiments, one or more such computer-implemented bathroom subsystem module may execute a bathroom cleaning process activation command received from an embodiment bathroom facility controller 135, depicted at ;east in FIGS. 1-3. In an illustrative example, each of the bathroom module 115, door controller 147, air dryer controller 152, sink controller 157, soap dispenser controller 162, toilet controller 167, cleaning robot controller 172, and cleaning robot storage compartment controller 177, may be implemented as distinct controller device instances based on the exemplary computing device 400 design, with each appliance controller instantiation configured with a distinct processor, memory, and processor executable program instruction module adapted to implement the disclosed appliance controller function.

FIG. 5 depicts an exemplary process flow of an embodiment autonomous modular bathroom facility cleaning method. The method depicted in FIG. 5 is given from the perspective of the ABCE 325 implemented via processor-executable program instructions executing on the bathroom facility controller 135 processor 305, depicted in FIG. 3. In the illustrated embodiment, the ABCE 325 executes as program instructions on the processor 305 configured in the ABCE 325 host bathroom facility controller 135, depicted in at least FIG. 1, FIG. 2, and FIG. 3. In some embodiments, the ABCE 325 may execute as a cloud service communicatively and operatively coupled with system services, hardware resources, or software elements local to and/or external to the ABCE 325 host bathroom facility controller 135. In an illustrative example, various embodiment ABCE 325 implementations may also be understood as from the perspective of a processor configured in the central online information hub 120, depicted in FIGS. 1 and 2. The depicted method 500 begins at step 505 with the processor 305 performing a test to determine if a bathroom user exit has been detected. In some embodiments, the processor 305 may detect user exit from the bathroom based on various sensor data. Upon a determination by the processor 305 at step 505 that a bathroom user exit has not been detected, the method continues at step 505. Upon a determination by the processor 305 at step 505 that a bathroom user exit has been detected, the method continues at step 510 with the processor 305 determining if the bathroom is occupied. In some implementations the processor 305 may determine occupancy based on one or more weight, thermal, or motion sensor. The method continues at step 515 with the processor 305 performing a test to determine if the bathroom is empty, based on the bathroom occupancy determined by the processor 305 at step 510. Upon a determination by the processor 305 at step 515 the bathroom is not empty, the method continues at step 505 with the processor 305 performing a test to determine if a bathroom user exit has been detected. Upon a determination by the processor 305 at step 515 the bathroom is empty, the method continues at step 520 with the processor 305 locking the bathroom door, and the method continues at step 525. At step 525 the processor 305 sends an electronic message including an instruction to clean the bathroom. In some examples, the instruction sent by the processor 305 to clean the bathroom may include one or more bathroom cleaning process activation command sent to one or more computer-implemented bathroom subsystem module, such as, for example, one or more of the bathroom module 115, door controller 147, air dryer controller 152, sink controller 157, soap dispenser controller 162, toilet controller 167, cleaning robot controller 172, or cleaning robot storage compartment controller 177, each depicted at least in FIG. 1. Then, the method continues at step 530 with the processor 305 unlocking the bathroom door, and the method continues at step 505 with the processor 305 performing a test to determine if a bathroom user exit has been detected.

In the depicted embodiment, the method repeats. In some embodiments, the method may pause for a predetermined period of time. In an example illustrative of various embodiments, the method may pause until the method resumes in response to a predetermined event or message. In some examples, the method may invoke one or more additional method.

In various embodiments, the ABCE 325 implementation executing as program instructions on the processor 305 may be designed with event-driven or interrupt-driven embedded programming techniques, to detect and process events based on received messages or captured sensor data, as would be known to one of ordinary skill in the art of embedded control systems. Some ABCE 325 embodiment implementations may designate various events as having different priorities, as a design decision within the scope of one having ordinary skill in the art. Various exemplary embodiment ABCE 325 implementations may process events having different priorities in an order different from the order in which the events were detected, based on configured event priority determined by a designer having ordinary skill in the art. In an illustrative example, the exemplary ABCE 325 process flow given with reference to the drawing represents an example of real-time asynchronous event handling, and an embodiment ABCE 325 process may handle events in a different order as a result of real-time conditions, design decisions, and other factors, as the skilled artisan would recognize. For example, an embodiment ABCE 325 process may prioritize an event related to user safety to be handled before an event related to user comfort.

In an illustrative example, the processor 305 may implement various operations based on sending one or more command to, or receiving one or more message or response from, one or more computer-implemented bathroom subsystem module, such as, for example, one or more of the bathroom module 115, door controller 147, air dryer controller 152, sink controller 157, soap dispenser controller 162, toilet controller 167, cleaning robot controller 172, or cleaning robot storage compartment controller 177, each depicted at least in FIG. 1. In some examples, various functional components of an embodiment ABCE 325 process implementation may be distributed among more than one computer-implemented bathroom subsystem module.

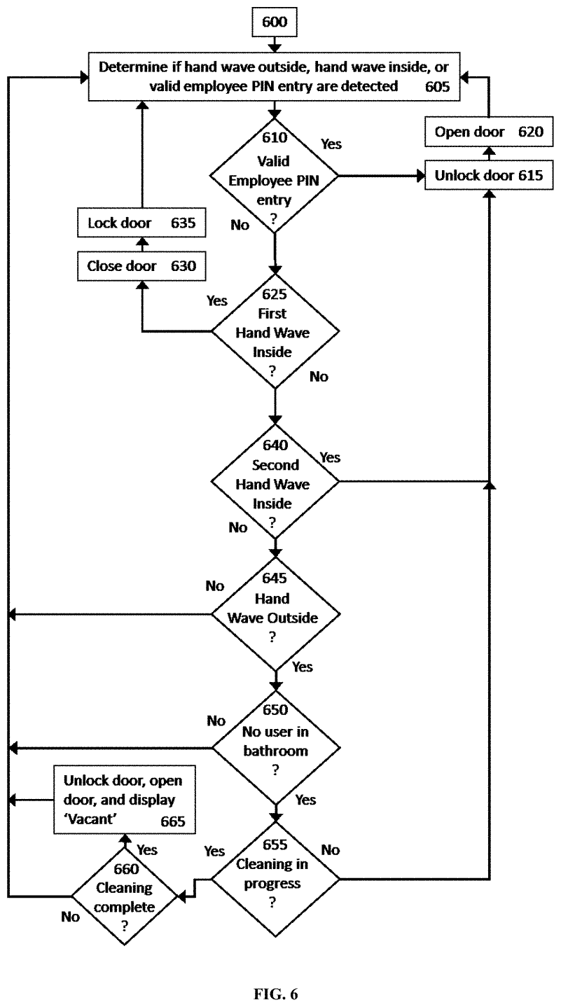

FIG. 6 depicts an exemplary process flow of an embodiment autonomous modular bathroom facility door lock/unlock method. The method depicted in FIG. 6 is given from the perspective of the ABCE 325 implemented via processor-executable program instructions executing on the bathroom facility controller 135 processor 305, depicted in FIG. 3. In the illustrated embodiment, the ABCE 325 executes as program instructions on the processor 305 configured in the ABCE 325 host bathroom facility controller 135, depicted in at least FIG. 1, FIG. 2, and FIG. 3. In some embodiments, the ABCE 325 may execute as a cloud service communicatively and operatively coupled with system services, hardware resources, or software elements local to and/or external to the ABCE 325 host bathroom facility controller 135. In an illustrative example, various embodiment ABCE 325 implementations may also be understood as from the perspective of a processor configured in the central online information hub 120, depicted in FIGS. 1 and 2. The depicted method 600 begins at step 605 with the processor 305 determining if a hand wave outside the bathroom, a hand wave inside the bathroom, or a valid employee PIN are detected. In some examples, a hand wave outside the bathroom may be detected by the processor 305 based on data captured from a sensor configured outside the bathroom. In various embodiments, a hand wave inside the bathroom may be detected by the processor 305 based on data captured from a sensor configured inside the bathroom. In an illustrative example, the processor 305 may detect a valid employee PIN entered by an employee in a mobile app, or a panel outside the bathroom.

In various embodiments, the ABCE 325 implementation executing as program instructions on the processor 305 may be designed with event-driven or interrupt-driven embedded programming techniques, to detect and process events based on received messages or captured sensor data, as would be known to one of ordinary skill in the art of embedded control systems. Some ABCE 325 embodiment implementations may designate various events as having different priorities, as a design decision within the scope of one having ordinary skill in the art. Various exemplary embodiment ABCE 325 implementations may process events having different priorities in an order different from the order in which the events were detected, based on configured event priority determined by a designer having ordinary skill in the art. In an illustrative example, the exemplary ABCE 325 process flow given with reference to the drawing represents an example of real-time asynchronous event handling, and an embodiment ABCE 325 process may handle events in a different order as a result of real-time conditions, design decisions, and other factors, as the skilled artisan would recognize. For example, an embodiment ABCE 325 process may prioritize an event related to user safety to be handled before an event related to supply inventory.

In an illustrative example, the processor 305 may implement various operations based on sending one or more command to, or receiving one or more message or response from, one or more computer-implemented bathroom subsystem module, such as, for example, one or more of the bathroom module 115, door controller 147, air dryer controller 152, sink controller 157, soap dispenser controller 162, toilet controller 167, cleaning robot controller 172, or cleaning robot storage compartment controller 177, each depicted at least in FIG. 1. In some examples, various functional components of an embodiment ABCE 325 process implementation may be distributed among more than one computer-implemented bathroom subsystem module.

Upon a determination at step 605 by the processor 305 a hand wave outside the bathroom, a hand wave inside the bathroom, or a valid employee PIN are detected, the method continues at step 610 with the processor 305 performing a test to determine if a valid employee PIN was entered.

Upon a determination at step 610 by the processor 305 a valid employee PIN was entered, the method continues at step 615 with the processor 305 unlocking the door. The method continues at step 620 with the processor 305 opening the door, and the method continues at step 605 with the processor 305 determining if a hand wave outside the bathroom, a hand wave inside the bathroom, or a valid employee PIN are detected.

Upon a determination at step 610 by the processor 305 a valid employee PIN was not entered, the method continues at step 625 with the processor 305 performing a test to determine if a first hand wave inside the bathroom is detected. Upon a determination at step 625 by the processor 305 a first hand wave inside the bathroom was detected, the method continues at step 630 with the processor 305 closing the door. The method continues at step 635 with the processor 305 locking the door, and the method continues at step 605 with the processor 305 determining if a hand wave outside the bathroom, a hand wave inside the bathroom, or a valid employee PIN are detected.

Upon a determination at step 625 by the processor 305 a first hand wave inside the bathroom was not detected, the method continues at step 640 with the processor 305 performing a test to determine if a second hand wave inside the bathroom is detected. Upon a determination at step 640 by the processor 305 a second hand wave inside the bathroom was detected, the method continues at step 615 with the processor 305 unlocking the door. The method continues at step 620 with the processor 305 opening the door, and the method continues at step 605 with the processor 305 determining if a hand wave outside the bathroom, a hand wave inside the bathroom, or a valid employee PIN are detected.

Upon a determination at step 640 by the processor 305 a second hand wave inside the bathroom was not detected, the method continues at step 645 with the processor 305 performing a test to determine if a hand wave outside the bathroom is detected. Upon a determination at step 645 by the processor 305 a hand wave outside the bathroom was not detected, the method continues at step 605 with the processor 305 determining if a hand wave outside the bathroom, a hand wave inside the bathroom, or a valid employee PIN are detected.

Upon a determination at step 645 by the processor 305 a hand wave outside the bathroom was detected, the method continues at step 650 with the processor 305 performing a test to determine if no user is in the bathroom. Upon a determination at step 650 by the processor 305 a user is in the bathroom, the method continues at step 605 with the processor 305 determining if a hand wave outside the bathroom, a hand wave inside the bathroom, or a valid employee PIN are detected.

Upon a determination at step 650 by the processor 305 no user is in the bathroom, the method continues at step 655 with the processor 305 performing a test to determine if cleaning is in progress. Upon a determination at step 655 by the processor 305 cleaning is not in progress, the method continues at step 615 with the processor 305 unlocking the door. The method continues at step 620 with the processor 305 opening the door, and the method continues at step 605 with the processor 305 determining if a hand wave outside the bathroom, a hand wave inside the bathroom, or a valid employee PIN are detected.

Upon a determination at step 655 by the processor 305 cleaning is in progress, the method continues at step 660 with the processor 305 performing a test to determine if cleaning is complete. Upon a determination at step 660 by the processor 305 cleaning is not complete, the method continues at step 605 with the processor 305 determining if a hand wave outside the bathroom, a hand wave inside the bathroom, or a valid employee PIN are detected.

Upon a determination at step 660 by the processor 305 cleaning is complete, the method continues at step 665 with the processor 305 unlocking the door, opening the door, and displaying “Vacant,” and the method continues at step 605 with the processor 305 determining if a hand wave outside the bathroom, a hand wave inside the bathroom, or a valid employee PIN are detected.

In various embodiment implementations, the method may repeat. In some embodiments, the method may pause for a predetermined period of time. In an example illustrative of various embodiments, the method may pause until the method resumes in response to a predetermined event or message. In some examples, the method may invoke one or more additional method.

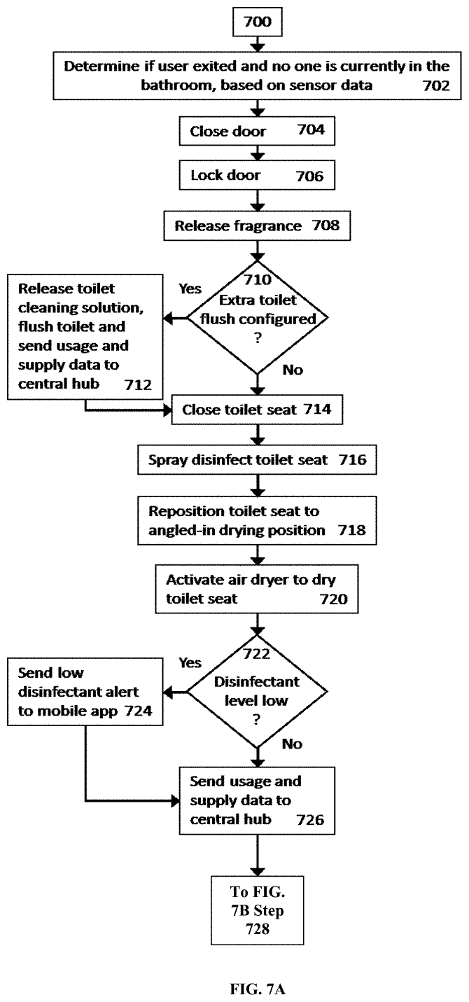

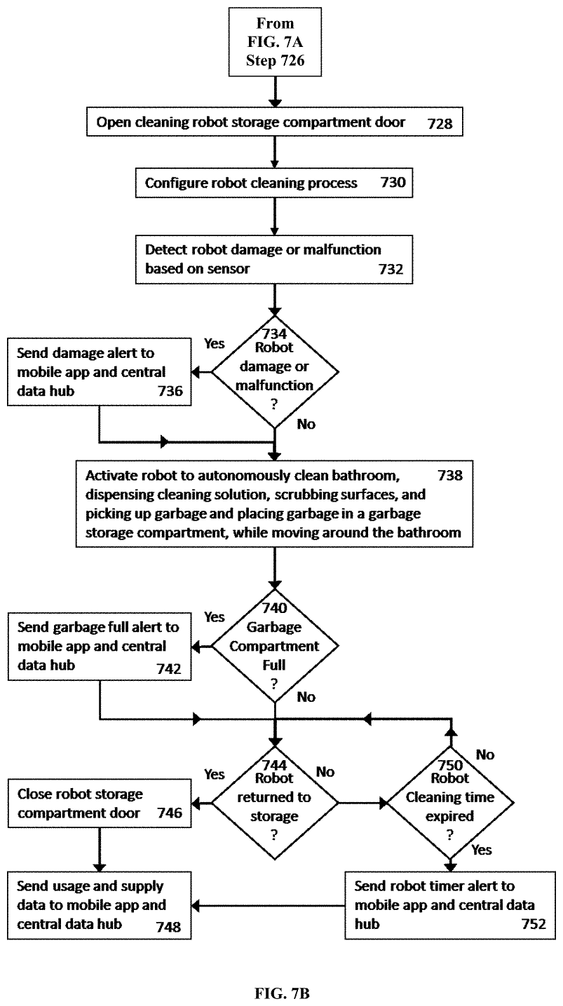

FIGS. 7A-7B together depict an exemplary process flow of an embodiment autonomous modular bathroom facility cleaning method. The method depicted in FIGS. 7A-7B is given from the perspective of the ABCE 325 implemented via processor-executable program instructions executing on the bathroom facility controller 135 processor 305, depicted in FIG. 3. In the illustrated embodiment, the ABCE 325 executes as program instructions on the processor 305 configured in the ABCE 325 host bathroom facility controller 135, depicted in at least FIG. 1, FIG. 2, and FIG. 3. In some embodiments, the ABCE 325 may execute as a cloud service communicatively and operatively coupled with system services, hardware resources, or software elements local to and/or external to the ABCE 325 host bathroom facility controller 135. In an illustrative example, various embodiment ABCE 325 implementations may also be understood as from the perspective of a processor configured in the central online information hub 120, depicted in FIGS. 1 and 2.

The depicted method 700 begins at step 702 illustrated in FIG. 7A with the processor 305 determining a user exited the bathroom, and no one is currently in the bathroom, based on sensor data. In some examples, the sensor data may include data captured from a motion sensor, a heat sensor, or a weight sensor. In an illustrative example, the user exit may be detected by the processor 305 based on a first sensor, and the determination by the processor 305 no one is currently in the bathroom may be based on a second sensor. Various embodiment autonomous self-cleaning bathroom designs may employ techniques known to one of ordinary skill in the art of sensor fusion to determine a user exited and no one is currently in the bathroom, based on embedded hardware and software techniques for processing data combined from more than one type of sensor.

In some embodiments, the ABCE 325 implementation executing as program instructions on the processor 305 may be designed with event-driven or interrupt-driven embedded programming techniques to detect and process events based on received messages or captured sensor data, as would be known to one of ordinary skill in the art of embedded control systems. Some ABCE 325 embodiment implementations may designate various events as having different priorities, as a design decision within the scope of one having ordinary skill in the art. Various exemplary embodiment ABCE 325 implementations may process events having different priorities in an order different from the order in which the events were detected, based on configured event priority determined by a designer having ordinary skill in the art. In an illustrative example, the exemplary ABCE 325 process flow given with reference to the drawing represents an example of real-time asynchronous event handling, and an embodiment ABCE 325 process may handle events in a different order as a result of real-time conditions, design decisions, and other factors, as the skilled artisan would recognize. For example, an embodiment ABCE 325 process may prioritize an event related to user safety to be handled before an event related to data collection.

In various embodiment examples, the processor 305 may implement various operations based on sending one or more command to, or receiving one or more message or response from, one or more computer-implemented bathroom subsystem module, such as, for example, one or more of the bathroom module 115, door controller 147, air dryer controller 152, sink controller 157, soap dispenser controller 162, toilet controller 167, cleaning robot controller 172, or cleaning robot storage compartment controller 177, each depicted at least in FIG. 1. In some examples, various functional components of an embodiment ABCE 325 process implementation may be distributed among more than one computer-implemented bathroom subsystem module.

Upon a determination at step 702 by the processor 305 that a user exited the bathroom and no one is currently in the bathroom, the method continues at step 704 with the processor 305 closing the door. Then, the method continues at step 706 with the processor 305 locking the door. The method continues at step 708 with the processor 305 releasing fragrance. In various embodiments, the quantity of fragrance released by the processor 305 may be configurable in the mobile app. Then, the method continues at step 710 with the processor 305 performing a test to determine if an extra toilet flush is configured. In various examples, the toilet may be configured to automatically flush once per use, wherein an extra toilet flush may be configured in the mobile app as an option. Upon a determination at step 710 by the processor 305 an extra toilet flush is configured, the method continues at step 712 with the processor 305 releasing toilet cleaning solution, flushing the toilet, and sending usage and supply data to the central data hub.

The method continues at step 714 with the processor 305 closing the toilet seat. Then, the method continues at step 716 with the processor 305 spray disinfecting the toilet seat. Then, the method continues at step 718 with the processor 305 repositioning the toilet seat to an angled-in drying position, and the method continues at step 720 with the processor 305 activating the air dryer to dry the toilet seat. At step 722, the processor 305 performs a test to determine if the toilet disinfectant level is low, based on sensor data captured from a sensor configured in the toilet. Upon a determination at step 722 by the processor 305 the toilet disinfectant level is low, the method continues at step 724 with the processor 305 sending a low disinfectant alert to the mobile app.

The method continues at step 726 with the processor 305 sending usage and supply data to the central data hub. Then, the method continues at step 728 illustrated in FIG. 7B with the processor 305 opening the cleaning robot storage compartment door. The method continues at step 730 with the processor 305 configuring the robot cleaning process. In some embodiments, the processor 305 may configure the cleaning robot to perform a specified level of cleaning, or direct the cleaning robot to clean a specified area. Then, the method continues at step 732 with the processor 305 detecting robot damage or malfunction based on sensor data analyzed by the processor 305. In various examples, the processor 305 may detect robot damage or malfunction based on one or more message received by the processor 305 from the cleaning robot. In various examples, a message received by the processor 305 from the cleaning robot may include data captured from one or more sensor configured in the cleaning robot to detect cleaning robot damage or malfunction. At step 734 the processor 305 performs a test to determine if cleaning robot damage or malfunction are detected, based on the cleaning robot damage or malfunction sensor data analyzed at step 732 by the processor 305. Upon a determination at step 734 by the processor 305 cleaning robot damage or malfunction are detected, the method continues at step 736 with the processor 305 sending a damage alert to the mobile app and central data hub.

The method continues at step 738 with the processor 305 activating the robot to autonomously clean the bathroom, dispensing cleaning solution, scrubbing surfaces, picking up garbage, and placing garbage in a garbage storage compartment, while the robot moves around the bathroom. Then, the method continues at step 740 with the processor 305 performing a test to determine if the robot garbage storage compartment is full, based on sensor data analyzed by the processor 305. In various embodiments, the processor 305 may determine if the robot garbage storage compartment is full based on receiving a message including captured data from a weight sensor or level sensor configured in the robot. Upon a determination at step 740 by the processor 305 the cleaning robot garbage storage compartment is full, the method continues at step 742 with the processor 305 sending a garbage full alert to the mobile app and central data hub.

The method continues at step 744 with the processor 305 performing a test to determine if the cleaning robot returned to the cleaning robot storage compartment, based on sensor data. In various examples, the processor 305 may determine if the cleaning robot returned to the cleaning robot storage compartment based on receiving a message including data captured from a sensor configured in the cleaning robot storage compartment. In various examples, the data captured from the sensor configured in the cleaning robot storage compartment may include weight sensor or proximity sensor data. Upon a determination at step 744 by the processor 305 the cleaning robot did not return to storage, the method continues at step 750 with the processor 305 performing a test to determine if the robot cleaning time expired. In various examples, the robot cleaning time may be configurable via the mobile app by an authorized employee. Upon a determination at step 750 by the processor 305 the robot cleaning time did not expire, the method continues at step 744 with the processor 305 performing a test to determine if the cleaning robot returned to the cleaning robot storage compartment, based on sensor data.

Upon a determination at step 744 by the processor 305 the cleaning robot returned to storage, the method continues at step 746 with the processor 305 closing the robot storage compartment door, and the method continues at step 748. Upon a determination at step 750 by the processor 305 the robot cleaning time expired, the method continues at step 752 with the processor 305 sending a robot return timer expired alert to the mobile app and central data hub. Then, the method continues at step 748 with the processor 305 sending usage and supply data to the mobile app and the central data hub.

In various embodiment implementations, the method may repeat. In some embodiments, the method may pause for a predetermined period of time. In an example illustrative of various embodiments, the method may pause until the method resumes in response to a predetermined event or message. In some examples, the method may invoke one or more additional method.

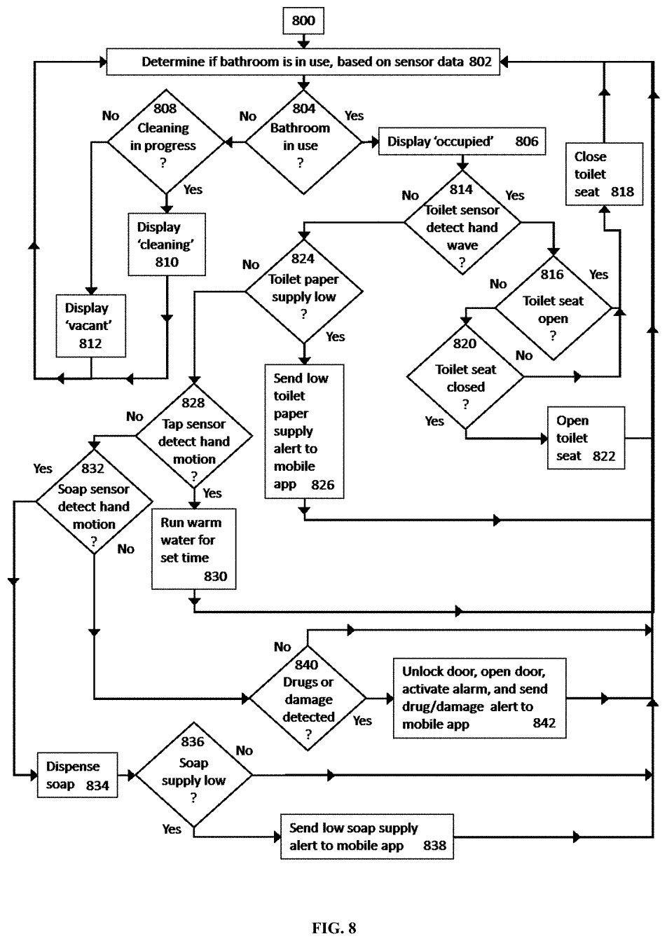

FIG. 8 depicts an exemplary process flow of an embodiment autonomous modular bathroom facility in-use method. The method depicted in FIG. 8 is given from the perspective of the ABCE 325 implemented via processor-executable program instructions executing on the bathroom facility controller 135 processor 305, depicted in FIG. 3. In the illustrated embodiment, the ABCE 325 executes as program instructions on the processor 305 configured in the ABCE 325 host bathroom facility controller 135, depicted in at least FIG. 1, FIG. 2, and FIG. 3. In some embodiments, the ABCE 325 may execute as a cloud service communicatively and operatively coupled with system services, hardware resources, or software elements local to and/or external to the ABCE 325 host bathroom facility controller 135. In an illustrative example, various embodiment ABCE 325 implementations may also be understood as from the perspective of a processor configured in the central online information hub 120, depicted in FIGS. 1 and 2. The depicted method 800 begins at step 802 with the processor 305 capturing sensor data to determine if the bathroom is in use, based on processor 305 analysis of the sensor data. At step 804 the processor 305 performs a test to determine if the bathroom is in use, based on the sensor data analysis by the processor 305 at step 802. In some examples, the sensor data may include data captured from a motion sensor, a heat sensor, or a weight sensor configured in the bathroom. In an illustrative example, the sensor data may include data captured from a biometric sensor. In some embodiments, the biometric sensor may include a sensor configured to measure the heart rate of a user in the bathroom. In an illustrative example, the heart rate measurement of the user in the bathroom may be based on video, images, or refracted light captured by one or more image or light sensor, using techniques known to one of ordinary skill in the art of remote photoplethysmography (rPPG). For example, in an embodiment method, the processor 305 may determine the bathroom is in use if weight sensor data indicates the bathroom floor is supporting a load of at least a predetermined weight, and if rPPG sensor data indicates a heart rate in a reasonable range for a human heart rate. In some embodiments, the rPPG sensor data may be based on processor 305 analysis of more than one video frame from a face-detecting camera configured to select an image region captured by a camera configured to detect a human face.

In an illustrative example, the ABCE 325 implementation executing as program instructions on the processor 305 may be designed with event-driven or interrupt-driven embedded programming techniques to detect and process events based on received messages or captured sensor data, as would be known to one of ordinary skill in the art of embedded control systems. Some ABCE 325 embodiment implementations may designate various events as having different priorities, as a design decision within the scope of one having ordinary skill in the art. Various exemplary embodiment ABCE 325 implementations may process events having different priorities in an order different from the order in which the events were detected, based on configured event priority determined by a designer having ordinary skill in the art. In an illustrative example, the exemplary ABCE 325 process flow given with reference to the drawing represents an example of real-time asynchronous event handling, and an embodiment ABCE 325 process may handle events in a different order as a result of real-time conditions, design decisions, and other factors, as the skilled artisan would recognize. For example, an embodiment ABCE 325 process may prioritize an event related to user safety to be handled before an event related to system maintenance.

In some embodiments, the processor 305 may implement various operations based on sending one or more command to, or receiving one or more message or response from, one or more computer-implemented bathroom subsystem module, such as, for example, one or more of the bathroom module 115, door controller 147, air dryer controller 152, sink controller 157, soap dispenser controller 162, toilet controller 167, cleaning robot controller 172, or cleaning robot storage compartment controller 177, each depicted at least in FIG. 1. In some examples, various functional components of an embodiment ABCE 325 process implementation may be distributed among more than one computer-implemented bathroom subsystem module.

Upon a determination at step 804 by the processor 305 the bathroom is in use, the method continues at step 806 with the processor 305 displaying “occupied,” and the method continues at step 814 with the processor 305 performing a test to determine if a hand wave is detected by the toilet sensor.

Upon a determination at step 814 by the processor 305 a hand wave was detected by the toilet sensor, the method continues at step 816 with the processor 305 performing a test to determine if the toilet seat is open.

Upon a determination at step 816 by the processor 305 the toilet seat is open, the method continues at step 818 with the processor 305 closing the toilet seat, and the method continues at step 802 with the processor 305 capturing sensor data to determine if the bathroom is in use, based on processor 305 analysis of the sensor data. Upon a determination at step 816 by the processor 305 the toilet seat is not open, the method continues at step 820 with the processor 305 performing a test to determine if the toilet seat is closed.

Upon a determination at step 820 by the processor 305 the toilet seat is not closed, the method continues at step 818 with the processor 305 closing the toilet seat, and the method continues at step 802 with the processor 305 capturing sensor data to determine if the bathroom is in use, based on processor 305 analysis of the sensor data. Upon a determination at step 820 by the processor 305 the toilet seat is closed, the method continues at step 822 with the processor 305 opening the toilet seat, and the method continues at step 802 with the processor 305 capturing sensor data to determine if the bathroom is in use, based on processor 305 analysis of the sensor data.

Upon a determination at step 804 by the processor 305 the bathroom is not in use, the method continues at step 808 with the processor 305 performing a test to determine if cleaning is in progress. Upon a determination at step 808 by the processor 305 cleaning is in progress, the method continues at step 810 with the processor 305 displaying “cleaning,” and the method continues at step 802 with the processor 305 capturing sensor data to determine if the bathroom is in use, based on processor 305 analysis of the sensor data. Upon a determination at step 808 by the processor 305 cleaning is not in progress, the method continues at step 812 with the processor 305 displaying “vacant,” and the method continues at step 802 with the processor 305 capturing sensor data to determine if the bathroom is in use, based on processor 305 analysis of the sensor data.

Upon a determination at step 814 by the processor 305 a hand wave was not detected by the toilet sensor, the method continues at step 824 with the processor 305 performing a test to determine if the toilet paper supply is low. In various embodiments, the toilet paper supply may be determined as a function of a sensor configured in the toilet paper dispenser. In some design embodiments, the sensor configured in the toilet paper dispenser may be a weight sensor adapted to measure the toilet paper supply level determined as a function of the force exerted on the sensor by the toilet paper as a result of the Earth's gravity. Upon a determination at step 824 by the processor 305 the toilet paper supply is low, the method continues at step 826 with the processor 305 sending a low toilet paper supply alert to the mobile app, and the method continues at step 802 with the processor 305 capturing sensor data to determine if the bathroom is in use, based on processor 305 analysis of the sensor data. Upon a determination at step 824 by the processor 305 the toilet paper supply is not low, the method continues at step 828 with the processor 305 performing a test to determine if hand motion is detected by the tap sensor. Upon a determination at step 828 by the processor 305 hand motion is detected by the tap sensor, the method continues at step 830 with the processor 305 running warm water from the tap for a set time period. In various examples, the time period warm water is run from the tap by the processor 305 may be configured via the mobile app. Then, the method continues at step 802 with the processor 305 capturing sensor data to determine if the bathroom is in use, based on processor 305 analysis of the sensor data.

Upon a determination at step 828 by the processor 305 hand motion is not detected by the tap sensor, the method continues at step 832 with the processor 305 performing a test to determine if hand motion is detected by the soap sensor. Upon a determination at step 832 by the processor 305 hand motion is not detected by the soap sensor, the method continues at step 840 with the processor 305 performing a test to determine if drug use in the bathroom or bathroom damage are detected. In various embodiments, the processor 305 may detect drug use based on a sensor configured to indicate the presence of specific chemical compounds in the air such as may be present in smoke or other vapor as a result of drug use. In some embodiments, the processor 305 may detect drug use based on computer vision technology configured to recognize human postures associated with drug use. In an illustrative example, the processor 305 may detect bathroom damage based on evaluating impacts to the bathroom measured as a function of data captured from an accelerometer configured in the bathroom. Some embodiments may detect bathroom damage based on detecting anomalies in data captured from various bathroom sensors at different times. For example, a temperature reading that is higher or lower than would be typical, in view of temporally related sensor data, may indicate structural damage to the bathroom. Upon a determination at step 840 by the processor 305 drug use or bathroom damage are detected, the method continues at step 842 with the processor 305 unlocking the door, opening the door, activating an alarm, and sending a drug/damage alert to the mobile app. The method continues at step 802 with the processor 305 capturing sensor data to determine if the bathroom is in use, based on processor 305 analysis of the sensor data.

Upon a determination at step 832 by the processor 305 hand motion is detected by the soap sensor, the method continues at step 834 with the processor 305 dispensing soap. The method continues at step 836 with the processor 305 performing a test to determine if the soap supply is low. In some embodiments, the processor 305 may determine if the soap supply is low based on data captured from a soap supply sensor. In an illustrative example, the soap supply sensor may be a weight sensor. In various design embodiments, the soap supply sensor may be a liquid level sensor. Upon a determination at step 836 by the processor 305 the soap supply is low, the method continues at step 838 with the processor 305 sending a low soap supply alert to the mobile app. The method continues at step 802 with the processor 305 capturing sensor data to determine if the bathroom is in use, based on processor 305 analysis of the sensor data.

In various embodiment implementations, the method may repeat. In some embodiments, the method may pause for a predetermined period of time. In an example illustrative of various embodiments, the method may pause until the method resumes in response to a predetermined event or message. In some examples, the method may invoke one or more additional method.

Although various embodiments have been described with reference to the Figures, other embodiments are possible. For example, various embodiment designs may be referred to as “The Stun CleanTech Bathroom.” Some embodiment implementations provide an autonomous bathroom cleaning system for commercial use. Various designs may include a 30 second process that locks the door, flushes the toilet, sterilizes the toilet seat, vacuums and sanitizes the bathroom floor and sprays an antiseptic fragrance into the air. Such an exemplary process may happen after each bathroom use and may be triggered by a user unlocking and exiting the bathroom, without another user entering.

In various embodiments, each part of the cleaning process may be initiated by software installed into each piece of hardware, which may be linked together by a wireless technology such as WiFi, or hardwired. Some embodiment cleaning processes may include more than one part, or all parts, of an exemplary cleaning process. In an illustrative example, by this connection, each piece of hardware may know when a cleaning process has started or finished and needs to activate or deactivate. In some designs, software may also feed usage, damage or consumable alert data through to a mobile app and central data hub.

Various embodiments' cleaning process may only begin when a user has exited the bathroom and if the sensors register there is no one in the bathroom. The sensors used to determine whether someone is in the bathroom may be either weight, motion or thermal. In some embodiments, the cleaning process may take up to 30 seconds, and may include:

1. Hands Free Door Open, Close, Lock
In some designs, the first step of the cleaning process may be for the door to automatically close and lock. In various embodiment implementations, the door cannot be opened during the cleaning process and will not start if a user is in the bathroom. In some designs, the door may be manually unlocked if necessary, from the outside using a pin code in the mobile app, and manually from the inside by pushing the door open.

2. Toilet Auto-Flush
In some embodiments, the toilet may be flushed automatically by a standard toilet motion sensor. For example, when a user moves away from the sensor, the toilet may be flushed. In some implementations, the toilet may also be flushed a second time when a user exits the bathroom as the second step of the cleaning process. This second flush can be set to on or off by the owner via the system's mobile app. A quantity of cleaning fluid will be released with each flush to sanitize the toilet bowl.

3. Bathroom Floor Cleaning
In an illustrative example, a third step of the cleaning process may be cleaning the bathroom floor using a floor cleaning robot like iRobot' s Brava mopping robot. In some embodiment, the robot may use anti-slip cleaning solution, stored in the robot, to clean the entire floor or areas of the floor needing attention. In various implementations, the robot may use a built-in mop to scrub the floor clean and a built-in vacuum to collect any discarded paper or waste on the floor. For example, the robot may store the paper in a compartment that needs to be emptied once full. In an illustrative example, the robot may detect if it's full using an ultrasonic fill-level sensor or weight sensor and send an alert via the mobile app.
To prevent vandalism, in some designs, the floor cleaning robot may store itself in a hidden compartment under the bathroom sink. The compartment may be fitted with a charging pad to ensure the robot can self-charge between cleans. In an illustrative example, when a cleaning process begins:
   A. The hidden compartment opens.
   B. The robot cleans the entire floor.
   C. The robot goes back into the compartment.
   D. The hidden compartment closes.
In some designs, the compartment may open and close using a rotating cog attached to a motor. For example, the motor may run forwards when the cleaning process starts, and backwards when the cleaning process is finished, raising and lowering the detached bottom 6″ of the sink/compartment. In some embodiments, the compartment may be locked during bathroom use to ensure the cavity under the sink cannot be accessed.

4. Toilet Seat Cleaning
In various implementations, the toilet seat may be cleaned when the cleaning process initiates. In an illustrative example, Step 4 of the cleaning process may happen simultaneously with step 3. For example, a disinfectant mist may be sprayed from multiple spraying outlets built in to the toilet seat cover to ensure the entire seat is sanitized. The seat may then be dried using air power from fans built into the toilet. To aid in the drying, the toilet seat may be angled inwards, ensuring any liquid on the seat is pushed into the bowl or dried.

5. Toilet Bowl Cleaning
In some designs, Step 5 of the process may clean the toilet bowl using a powerful flushing mechanism that mixes with a cleaning solution as it flushes. In some examples, this cleaning solution may be housed in the toilet cistern and is set to release a specific amount each time the toilet is flushed. In an illustrative example, rather than flushing down into the bowl, the mechanism may be configured to flush at an angle for an even and complete clean.

6. Fragrance
In some examples, Step 6 of the cleaning process may happen simultaneously with steps 4 & 5. For example, a sanitizing fragrance may be dispensed from a spray mechanism securely fastened onto the wall in a locked cartridge. This mechanism may be set to spray once per cleaning process. The spray mechanism may be similar to an automated aerosol spray powered by electricity.

Hands Free Bathroom Use

In an example illustrative of various embodiments' usage, to enter the bathroom, a user may wave their hand across a sensor which unlocks and opens the door. When a user exits the bathroom, the bathroom door closes and locks automatically, starting the cleaning process. If someone is in the bathroom, the door cannot be unlocked from the outside (unless overridden by the store staff or law enforcement). To determine whether someone is in the bathroom already, the system may use the same weight, motion or thermal sensor as the cleaning process. The sink, soap and hand dryer are all activated using motion sensors. Various embodiments may include voice activation as an option in multiple languages. In an illustrative example, an embodiment self-cleaning bathroom implementation may include voice activation in multiple languages configured to activate the sink, soap, hand dryer, toilet flush, or door lock, in response to voice commands. Some embodiment voice activated self-cleaning bathroom appliances or cleaning processes may be adapted to recognize specific human speakers for certain operations. For example, various embodiments may be configured to activate or override predetermined voice activated features or processes only for the owner's voice identified by an embodiment voice-activated autonomous self-cleaning bathroom. In some designs, when a user places their hand in front of a motion sensor, one of the following may happen:
1. Warm or cold water runs for 10 seconds, or as long as hands are held in front of the sensor.
2. The soap fixture dispenses a predetermined amount (for example, 10 ml) of soap, or an amount of soap to be configured by the owner, or an amount of soap specified by the user.
3. The hand dryer pumps out hot air for 10 seconds, or as long as the hands are held in front of the sensor.

Data Collection & Inventory Management

In various embodiments, the system will collect data, sending it to a mobile app for the owner and a central online information hub. The collected data may include bathroom uses, cleaning cycles completed, soap liquid levels, toilet cleaning solution levels, fragrance levels, toilet paper levels and number of refills.

In some implementations, liquid levels may be measured using a point level sensor, the toilet paper is measured using a weight sensor. In an illustrative example, when the cleaning liquid or toilet paper reaches a designated “low” level it sends an alert to the mobile app notifying the owner a refill needs to be made.

In some designs, if an individual bathroom has gone through a set number of refills, the system notifies the central data hub. For example, this automatically dispatches a shipment of refills to that location. The exemplary auto-ordering system can be adjusted or overridden manually.

In some embodiment implementations, if the floor robot or piece of hardware in the bathroom is detected by the software to be defective, a notification is sent to the central data hub where a technician can be notified and dispatched.

Bathroom Components

Various embodiment CleanTech bathroom implementations may include but are not limited to the following components:
Toilet, including the seat and motion sensor.
Sink including the water, air and soap dispensers.
Attached sink compartment for the cleaning robot. Including the detached bottom of the sink compartment and mechanism for opening/closing.
Floor cleaning robot.
Fragrance dispenser and secure cartridge.
Motion sensors for door.
Door locking mechanism.
Mobile app.
Stun Cleantech software system to link all components together for activation and monitoring.

In some embodiments, a CleanTech bathroom design may be made to be easily transportable. In an illustrative example, an embodiment implementation may be plug-and-use initially for convenience stores with no specialized electrical or plumbing work needed.

Some embodiment bathroom designs may be built to work with the existing wiring and plumbing. In an illustrative example, an embodiment bathroom may be built using plastics such as polystyrene, metals such as aluminum, silicon and porcelain.

Bathroom as a Service (BaaS) Model

The BaaS model is a bathroom licensing and delivery model where the services for a bathroom, in this case our CleanTech bathroom, are licensed on a subscription basis. These services include, but are not limited to cleaning solution refills, inventory management for bathroom cleaning products, software updates, maintenance fixes, hardware replacements, CleanTech analytics and support. It's a model based on a PaaS or SaaS but is solely focused on the self-cleaning bathroom.

The BaaS model is easily scalable with clients paying per bathroom they have active. By opting into the BaaS subscription, all the services needed to clean and maintain the bathroom are covered by the monthly subscription fee. Clients sign a contract for a pre-determined number of years and pay monthly or yearly fee for the services. The services are all fulfilled by CleanTech or outsourced suppliers contracted by CleanTech.

Terms
Owner: The store manager or employee where the bathroom is located.
User: The person who is using the bathroom.
System: The software that connects everything, activates the cleaning process and collects data.
CleanTech Bathroom: A bathroom that uses the Stun CleanTech system to provide a handsfree autonomous system for the User and a self-cleaning process for the Owner.

Door Lock/Unlock Process

Various embodiment implementations may perform a door lock/unlock process. In illustrative, non-limiting examples, an embodiment door lock/unlock process may open, close, lock and unlock on the bathroom door on command. In some embodiments, a screen outside the bathroom may show instructions on how to open the door, as well as the status of the bathroom, such as if the bathroom is occupied or being cleaned. In various designs, the door lock, door hinges, and door sensors may all be connected to an embodiment CleanTech system. In an illustrative example, an embodiment door lock/unlock process may include steps similar to the following steps:
1. When a user waves their hand in front of the sensor/screen outside the bathroom, the door opens without touch, using something such as embedded software, if the following conditions are met:
   a. No one is currently in the bathroom, which is determined by a sensor.
   b. The cleaning cycle is not in process.
2. The screen will be an industry standard motion sensor touchscreen, programmed to work with the necessary content.
3. The doors and locks will be industry standard.
4. When a user waves their hand in front of the sensor/screen inside the bathroom, using embedded software, the door closes and locks.
5. When a user waves their hand in front of the sensor/screen inside the bathroom again, the door unlocks, and opens.
6. When a cleaning cycle has finished, the doors unlock and open. The sensor/screen outside the bathroom will show the status as “vacant”
7. If an employee's puts a PIN code into their mobile app, the bathroom door unlocks and opens. This will override both previous conditions.

Cleaning Process

Various embodiment implementations may perform a cleaning process. In illustrative, non-limiting examples, an embodiment cleaning process may only begin when a user has exited the bathroom and if a sensor registers there is no one in the bathroom. In an illustrative example, an embodiment cleaning process may take up to 30 seconds and consist of steps similar to the following steps:
1. Toilet Flush & Toilet Bowl Cleaning
   The toilet will be custom made for the purpose of this project and able to handle embedded software. The powerful flush and ability to mix cleaning solution with the flush will be built in.
      a. The toilet is flushed automatically while the user is in the bathroom by an industry standard motion sensor.
      b. The toilet can be flushed again when a user exits the bathroom. This second flush can be turned on or off by the owner via the system's mobile app. This second flush would occur as soon as the door locks and the cleaning process initiates. It will connect to the CleanTech system with something such as embedded software.
      c. This cleaning solution is housed in the toilet cistern and is set to release a specific amount each time the toilet is flushed using embedded software.
      d. Number of flushes needs to be monitored with embedded software for usage reports.
2. Bathroom Floor Cleaning
   The floor cleaning robot will utilize custom programming and embedded software to connect with the bathroom system.
      a. A mechanical system opens a hidden compartment under the sink when the cleaning process initiates. This is where the floor cleaning robot lives. The compartment door will be connected to the bathroom system using embedded software.
      b. The bathroom floor cleaning robot will be pre-programmed to move around the bathroom and clean it when the compartment is opened. A set amount of anti-slip cleaning solution will be used during the cleaning process.
      c. The robot will pick up any garbage on the floor. When the robot is full of garbage, a sensor will send off an alert to the employees via the mobile app.
      d. When the robot has cleaned the entire floor, it will go back under the sink, and the mechanical system will close the compartment, hiding the robot.
      e. The robot will sit on a wireless charging pad in the compartment to ensure it doesn't run out of battery.
      f. If the robot is damaged or not working properly, this is detected, and a diagnostic report is sent to the mobile app and central data hub. This will be pre-programmed in.
      g. If the robot does not finish its cleaning cycle within 30 seconds, this is detected, and an alert should be sent to the mobile app.
3. Toilet Seat Cleaning
   a. The toilet seat cleaning initiates once the toilet has flushed a second time, or the cleaning process has started. It will be connected to the bathroom system using embedded software.
   b. The toilet seat will close automatically using an embedded software trigger.
   c. A disinfectant mist is then sprayed from multiple spraying outlets built-in to the toilet seat cover to ensure the entire seat is sanitized. This will be triggered using embedded software.
   d. The seat is then dried using air power from fans built into the toilet. To aid in the drying, the toilet seat is angled inwards, ensuring any liquid on the seat is pushed into the bowl or dried.
   e. The disinfectant liquid needs to be monitored, when it gets below a set amount, an alert will be sent to the mobile app using embedded software.
4. Fragrance
   a. A locked cartridge holding an industry standard aerosol fragrance spray will be mounted on the wall.
   b. The fragrance sprays and the end of the cleaning process, a few seconds before the doors unlock. This is triggered by embedded software.
   c. A specific amount of sanitizing fragrance is dispensed once per cleaning process.
   d. The level of liquid in the cartridge needs to be monitored, when it gets below a set amount, an alert is sent to the mobile app using embedded software.

Bathroom “In Use” Processes

Various embodiment implementations may perform a bathroom “In Use” process. In illustrative, non-limiting examples, an embodiment Bathroom “In Use” Process may include steps similar to the following steps:
1. Toilet Seat
   a. A user waves their hand in front of a sensor to open/shut the toilet seat for a completely hands-free experience.
2. Toilet Paper Use
   a. Toilet paper levels need to be monitored, likely by a weight sensor. When it gets below a set amount, an alert will be sent to the mobile app.
3. Hand Washing
   a. When a user places their hands under the tap, it will trigger a motion sensor. Warm water will flow for a set amount of time.
   b. When a user places their hands under the soap fixture, it will trigger a standard motion sensor. The soap fixture will dispense a set amount of soap.
   c. Sensors will monitor the level of soap, when it gets below a set amount, an alert is sent to the mobile app.
4. Hand Drying
   a. When a user places their hands under the dryer, it will trigger a motion sensor. Hot air will flow for a set amount of time.
5. Damage/Drug Detection
   a. Sensors will scan the bathroom while in use.
   b. If the sensors detect drug use or damage within the bathroom, the door unlocks and opens. An alarm connected to the CleanTech system also goes off.
   c. The alarm will connect with the system using embedded software.
   d. Sensors will be connected to embedded software.

Toilet Specifications

Various embodiments may include a toilet. In illustrative non-limiting examples, a toilet in accordance with embodiments of the present disclosure may have specifications similar to the following:
1. Toilet Flush
   a. The toilet has strong flushing pressure. This should have stronger pressure than an average residential toilet.
   b. The toilet should flush from the side, in a circular motion, rather than from the top of the bowl down.
   c. The toilet flush should mix a pre-determined amount of cleaning liquid into the water with each flush.
   d. The toilet should flush automatically using sensors. When a user moves away from a sensor, it should flush the toilet.
2. Toilet Seat
   a. The seat should have a mechanism that allows it to open and close when prompted from embedded software, without human interaction.
   b. The seat should be self-cleaning using a disinfectant seat cleaning mist to clean and warm air to dry.
   c. The toilet seat should be fitted with misters to dispense the disinfectant cleaning mist.
   d. The toilet seat/tank should be fitted with a solution to dry the seat, once sprayed with cleaning liquid. One potential solution is warm air.
3. Toilet Tank
   a. Standard tank, with the ability to hold embedded software.
   b. Hold the cleaning solution that gets mixed with each flush.
   c. Hold the disinfectant liquid that cleans the toilet seat.
4. Toilet Structure
   a. The toilet structure can be of standard size/shape.
   b. The toilet needs to be easy to install in a standard bathroom.
   c. Cartridges that contain cleaning detergents for the bowl and seat disinfectant should be easily replaced and contain sufficient quantities of detergent for up to 1,000 cleans.
5. Embedded Software
   Embedded software should be able to be placed in locations to track and/or trigger events similar to the following:
      a. Toilet Flushing
         i. Track when a toilet is flushed.
         ii. Control the mechanism to flush the toilet when prompted.
      b. Seat opening/closing.
         i. Control the mechanism to close/open the seat when prompted.
      c. Cleaning solution dispenser.
         i. Control the mechanism to dispense the correct amount of cleaning solution when prompted.
      d. Central unit to communicate with the rest of the cleaning process.

Other Features

In illustrative non-limiting examples, various embodiments may include additional features such as the following:
1. Wall Treatment
   Treatment/Material for the walls to prevent stains and spray-paint/permanent markets (such as, for example, Electrostatic technology).
2. Inventory Management
   a. When a set amount of refills have been made by employees, the CleanTech system will notify the franchise manager via the mobile app and the central data hub.
   b. Unrelated to the embedded software, the central data hub will then dispatch a new shipment of refills using a supply chain system set in place.
   c. The inventory that needs to be monitored and managed are:
      i. Hand Soap
      ii. Toilet Bowl Cleaning Solution
      iii. Fragrance Liquid
      iv. Floor Robot Anti-Slip Mopping Liquid
      v. Toilet Paper

In the Summary above and in this Detailed Description, and the Claims below, and in the accompanying drawings, reference is made to particular features of various embodiments of the invention. It is to be understood that the disclosure of embodiments of the invention in this specification includes all possible combinations of such particular features. For example, where a particular feature is disclosed in the context of a particular aspect or embodiment of the invention, or a particular claim, that feature can also be used—to the extent possible—in combination with and/or in the context of other particular aspects and embodiments of the invention, and in the invention generally.

While multiple embodiments are disclosed, still other embodiments of the present invention will become apparent to those skilled in the art from this detailed description. The invention is capable of myriad modifications in various obvious aspects, all without departing from the spirit and scope of the present invention. Accordingly, the drawings and descriptions are to be regarded as illustrative in nature and not restrictive.

It should be noted that the features illustrated in the drawings are not necessarily drawn to scale, and features of one embodiment may be employed with other embodiments as the skilled artisan would recognize, even if not explicitly stated herein. Descriptions of well-known components and processing techniques may be omitted so as to not unnecessarily obscure the embodiments.

In the present disclosure, various features may be described as being optional, for example, through the use of the verb “may;”, or, through the use of any of the phrases: “in some embodiments,” “in some implementations,” “in some designs,” “in various embodiments,” “in various implementations,”, “in various designs,” “in an illustrative example,” or “for example;” or, through the use of parentheses. For the sake of brevity and legibility, the present disclosure does not explicitly recite each and every permutation that may be obtained by choosing from the set of optional features. However, the present disclosure is to be interpreted as explicitly disclosing all such permutations. For example, a system described as having three optional features may be embodied in seven different ways, namely with just one of the three possible features, with any two of the three possible features or with all three of the three possible features.

In various embodiments, elements described herein as coupled or connected may have an effectual relationship realizable by a direct connection or indirectly with one or more other intervening elements.

In the present disclosure, the term “any” may be understood as designating any number of the respective elements, i.e. as designating one, at least one, at least two, each or all of the respective elements. Similarly, the term “any” may be understood as designating any collection(s) of the respective elements, i.e. as designating one or more collections of the respective elements, a collection comprising one, at least one, at least two, each or all of the respective elements. The respective collections need not comprise the same number of elements.

While various embodiments of the present invention have been disclosed and described in detail herein, it will be apparent to those skilled in the art that various changes may be made to the configuration, operation and form of the invention without departing from the spirit and scope thereof In particular, it is noted that the respective features of embodiments of the invention, even those disclosed solely in combination with other features of embodiments of the invention, may be combined in any configuration excepting those readily apparent to the person skilled in the art as nonsensical. Likewise, use of the singular and plural is solely for the sake of illustration and is not to be interpreted as limiting.

In the present disclosure, all embodiments where “comprising” is used may have as alternatives “consisting essentially of,” or “consisting of.” In the present disclosure, any method or apparatus embodiment may be devoid of one or more process steps or components. In the present disclosure, embodiments employing negative limitations are expressly disclosed and considered a part of this disclosure.

Certain terminology and derivations thereof may be used in the present disclosure for convenience in reference only and will not be limiting. For example, words such as “upward,” “downward,” “left,” and “right” would refer to directions in the drawings to which reference is made unless otherwise stated. Similarly, words such as “inward” and “outward” would refer to directions toward and away from, respectively, the geometric center of a device or area and designated parts thereof. References in the singular tense include the plural, and vice versa, unless otherwise noted.

The term “comprises” and grammatical equivalents thereof are used herein to mean that other components, ingredients, steps, among others, are optionally present. For example, an embodiment “comprising” (or “which comprises”) components A, B and C can consist of (i.e., contain only) components A, B and C, or can contain not only components A, B, and C but also contain one or more other components.

Where reference is made herein to a method comprising two or more defined steps, the defined steps can be carried out in any order or simultaneously (except where the context excludes that possibility), and the method can include one or more other steps which are carried out before any of the defined steps, between two of the defined steps, or after all the defined steps (except where the context excludes that possibility).

The term “at least” followed by a number is used herein to denote the start of a range beginning with that number (which may be a range having an upper limit or no upper limit, depending on the variable being defined). For example, “at least 1” means 1 or more than 1. The term “at most” followed by a number (which may be a range having 1 or 0 as its lower limit, or a range having no lower limit, depending upon the variable being defined). For example, “at most 4” means 4 or less than 4, and “at most 40%” means 40% or less than 40%. When, in this specification, a range is given as “(a first number) to (a second number)” or “(a first number)—(a second number),” this means a range whose limit is the second number. For example, 25 to 100 mm means a range whose lower limit is 25 mm and upper limit is 100 mm.

Many suitable methods and corresponding materials to make each of the individual parts of embodiment apparatus are known in the art. According to an embodiment of the present invention, one or more of the parts may be formed by machining, 3D printing (also known as “additive” manufacturing), CNC machined parts (also known as “subtractive” manufacturing), and injection molding, as will be apparent to a person of ordinary skill in the art. Metals, wood, thermoplastic and thermosetting polymers, resins and elastomers as may be described herein-above may be used. Many suitable materials are known and available and can be selected and mixed depending on desired strength and flexibility, preferred manufacturing method and particular use, as will be apparent to a person of ordinary skill in the art.

Any element in a claim herein that does not explicitly state “means for” performing a specified function, or “step for” performing a specific function, is not to be interpreted as a “means” or “step” clause as specified in 35 U.S.C. § 112(f). Specifically, any use of “step of” in the claims herein is not intended to invoke the provisions of 35 U.S.C. § 112 (f).

According to an embodiment of the present invention, the system and method may be accomplished through the use of one or more computing devices. As depicted, for example, at least in FIG. 1, FIG. 2, FIG. 3, and FIG. 4, one of ordinary skill in the art would appreciate that an exemplary system appropriate for use with embodiments in accordance with the present application may generally include one or more of a Central Processing Unit (CPU), Random Access Memory (RAM), a storage medium (e.g., hard disk drive, solid state drive, flash memory, cloud storage), an operating system (OS), one or more application software, a display element, one or more communications means, or one or more input/output devices/means. Examples of computing devices usable with embodiments of the present invention include, but are not limited to, proprietary computing devices, personal computers, mobile computing devices, tablet PCs, mini-PCs, servers or any combination thereof. The term computing device may also describe two or more computing devices communicatively linked in a manner as to distribute and share one or more resources, such as clustered computing devices and server banks/farms. One of ordinary skill in the art would understand that any number of computing devices could be used, and embodiments of the present invention are contemplated for use with any computing device.

In various embodiments, communications means, data store(s), processor(s), or memory may interact with other components on the computing device, in order to effect the provisioning and display of various functionalities associated with the system and method detailed herein. One of ordinary skill in the art would appreciate that there are numerous configurations that could be utilized with embodiments of the present invention, and embodiments of the present invention are contemplated for use with any appropriate configuration.

According to an embodiment of the present invention, the communications means of the system may be, for instance, any means for communicating data over one or more networks or to one or more peripheral devices attached to the system. Appropriate communications means may include, but are not limited to, circuitry and control systems for providing wireless connections, wired connections, cellular connections, data port connections, Bluetooth connections, or any combination thereof. One of ordinary skill in the art would appreciate that there are numerous communications means that may be utilized with embodiments of the present invention, and embodiments of the present invention are contemplated for use with any communications means.

Throughout this disclosure and elsewhere, block diagrams and flowchart illustrations depict methods, apparatuses (i.e., systems), and computer program products. Each element of the block diagrams and flowchart illustrations, as well as each respective combination of elements in the block diagrams and flowchart illustrations, illustrates a function of the methods, apparatuses, and computer program products. Any and all such functions (“depicted functions”) can be implemented by computer program instructions; by special-purpose, hardware-based computer systems; by combinations of special purpose hardware and computer instructions; by combinations of general purpose hardware and computer instructions; and so on—any and all of which may be generally referred to herein as a “circuit,” “module,” or “system.”

While the foregoing drawings and description may set forth functional aspects of the disclosed systems, no particular arrangement of software for implementing these functional aspects should be inferred from these descriptions unless explicitly stated or otherwise clear from the context.

Each element in flowchart illustrations may depict a step, or group of steps, of a computer-implemented method. Further, each step may contain one or more sub-steps. For the purpose of illustration, these steps (as well as any and all other steps identified and described above) are presented in order. It will be understood that an embodiment can contain an alternate order of the steps adapted to a particular application of a technique disclosed herein. All such variations and modifications are intended to fall within the scope of this disclosure. The depiction and description of steps in any particular order is not intended to exclude embodiments having the steps in a different order, unless required by a particular application, explicitly stated, or otherwise clear from the context.

Traditionally, a computer program consists of a sequence of computational instructions or program instructions. It will be appreciated that a programmable apparatus (i.e., computing device) can receive such a computer program and, by processing the computational instructions thereof, produce a further technical effect.

A programmable apparatus may include one or more microprocessors, microcontrollers, embedded microcontrollers, programmable digital signal processors, programmable devices, programmable gate arrays, programmable array logic, memory devices, application specific integrated circuits, or the like, which can be suitably employed or configured to process computer program instructions, execute computer logic, store computer data, and so on. Throughout this disclosure and elsewhere a computer can include any and all suitable combinations of at least one general purpose computer, special-purpose computer, programmable data processing apparatus, processor, processor architecture, and so on.

It will be understood that a computer can include a computer-readable storage medium and that this medium may be internal or external, removable and replaceable, or fixed. It will also be understood that a computer can include a Basic Input/Output System (BIOS), firmware, an operating system, a database, or the like that can include, interface with, or support the software and hardware described herein.

Embodiments of the system as described herein are not limited to applications involving conventional computer programs or programmable apparatuses that run them. It is contemplated, for example, that embodiments of the invention as claimed herein could include an optical computer, quantum computer, analog computer, or the like.

Regardless of the type of computer program or computer involved, a computer program can be loaded onto a computer to produce a particular machine that can perform any and all of the depicted functions. This particular machine provides a means for carrying out any and all of the depicted functions.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

Computer program instructions can be stored in a computer-readable memory capable of directing a computer or other programmable data processing apparatus to function in a particular manner. The instructions stored in the computer-readable memory constitute an article of manufacture including computer-readable instructions for implementing any and all of the depicted functions.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

The elements depicted in flowchart illustrations and block diagrams throughout the figures imply logical boundaries between the elements. However, according to software or hardware engineering practices, the depicted elements and the functions thereof may be implemented as parts of a monolithic software structure, as standalone software modules, or as modules that employ external routines, code, services, and so forth, or any combination of these. All such implementations are within the scope of the present disclosure.

Unless explicitly stated or otherwise clear from the context, the verbs “execute” and “process” are used interchangeably to indicate execute, process, interpret, compile, assemble, link, load, any and all combinations of the foregoing, or the like. Therefore, embodiments that execute or process computer program instructions, computer-executable code, or the like can suitably act upon the instructions or code in any and all of the ways just described.

The functions and operations presented herein are not inherently related to any particular computer or other apparatus. Various general-purpose systems may also be used with programs in accordance with the teachings herein, or it may prove convenient to construct more specialized apparatus to perform the required method steps. The required structure for a variety of these systems will be apparent to those of skill in the art, along with equivalent variations. In addition, embodiments of the invention are not described with reference to any particular programming language. It is appreciated that a variety of programming languages may be used to implement the present teachings as described herein, and any references to specific languages are provided for disclosure of enablement and best mode of embodiments of the invention. Embodiments of the invention are well suited to a wide variety of computer network systems over numerous topologies. Within this field, the configuration and management of large networks include storage devices and computers that are communicatively coupled to dissimilar computers and storage devices over a network, such as the Internet.

A number of implementations have been described. Nevertheless, it will be understood that various modifications may be made. For example, advantageous results may be achieved if the steps of the disclosed techniques were performed in a different sequence, or if components of the disclosed systems were combined in a different manner, or if the components were supplemented with other components. Accordingly, other implementations are contemplated within the scope of the following claims.

What is claimed is:

1. An autonomous self-cleaning bathroom apparatus, comprising:
a substantially enclosed bathroom structure configured with a lockable door adapted to permit a human to enter and exit the bathroom structure through the door, wherein the lockable door includes a door lock operable to lock the door in response to receiving a command to lock the door, and wherein the door lock is operable to unlock the door in response to receiving a command to unlock the door;
a floor, attached to the bathroom structure, wherein the floor is adapted to support the weight of a human within the bathroom structure;
a human passage sensor adapted to detect human entry or exit through the door, wherein the human passage sensor is configured to send an indication of human passage through the door;
a human presence sensor adapted to detect the presence of a human within the bathroom structure, wherein the human presence sensor is configured to send an indication of whether a human is present within the bathroom structure;
at least one computer-implemented bathroom subsystem module configured to execute a bathroom cleaning process in response to receiving a bathroom cleaning process activation command; and,
a bathroom controller, comprising:
one or more processor;
a communication interface operably and communicatively coupling at least one processor of the one or more processor with the door lock, the human passage sensor, the human presence sensor, and the at least one computer-implemented bathroom subsystem module;
a memory that is not a transitory propagating signal, the memory operably and communicatively coupled with the one or more processor and encoding computer readable instructions, including processor executable program instructions, the computer readable instructions accessible to the one or more processor, wherein the processor executable program instructions, when executed by the one or more processor, cause the one or more processor to perform operations comprising:
determine if a user exited the bathroom;
in response to a determination a user exited the bathroom:
determine if a user remains in the bathroom;
upon a determination no user remains in the bathroom:
lock the bathroom door; and,
clean the bathroom.

2. The apparatus of claim 1, wherein the door includes a hinge movably coupling the door with the bathroom structure to permit the door to open and close, and wherein the human passage sensor is configured to detect the hinge motion.

3. The apparatus of claim 2, wherein the indication of human passage through the door sent by the human passage detector includes the hinge motion direction, and wherein determine if a user exited the bathroom is determined as a function of the hinge motion direction.

4. The apparatus of claim 1, wherein the human presence sensor includes a heat sensor.

5. The apparatus of claim 1, wherein the human presence sensor further comprises a weight sensor configured in the floor, and wherein the indication of whether a human is present within the bathroom structure further comprises weight sensor data.

6. The apparatus of claim 5, wherein determine if a user remains in the bathroom further comprises determining the number of human occupants within the bathroom as a function of the weight sensor data.

7. The apparatus of claim 1, wherein the at least one computer-implemented bathroom subsystem module further comprises a toilet, and wherein the bathroom cleaning process further comprises flush the toilet.

8. The apparatus of claim 1, wherein the at least one computer-implemented bathroom subsystem module further comprises an autonomous floor-cleaning robot configured to clean the floor, and wherein the bathroom cleaning process executed by the floor-cleaning robot further comprises cleaning the floor.

9. The apparatus of claim 1, wherein the apparatus further comprises a computer-implemented central hub communicatively and operably coupled with the bathroom facility controller, wherein the central hub is configured to receive usage, status, and consumable alert data from the bathroom facility controller.

10. An autonomous self-cleaning bathroom apparatus, comprising:
a substantially enclosed bathroom structure configured with a lockable door adapted to permit a human to enter and exit the bathroom structure through the door, wherein the lockable door includes a door lock operable to lock the door in response to receiving a command to lock the door, and wherein the door lock is operable to unlock the door in response to receiving a command to unlock the door;
a hinge, movably coupling the door with the bathroom structure to permit the door to open and close, wherein the hinge includes a door actuator configured to open the door in response to receiving a command to open the door, and wherein the door actuator is configured to close the door in response to receiving a command to close the door;
an outside human hand gesture sensor configured in the door outside the bathroom structure, wherein the outside human hand gesture sensor is adapted to detect a human hand gesture outside the door, and wherein the outside human hand gesture sensor is configured to send an indication including the gesture detected by the gesture sensor;
an inside human hand gesture sensor configured in the door inside the bathroom structure, wherein the inside human hand gesture sensor is adapted to detect a human hand gesture inside the door, and wherein the inside human hand gesture sensor is configured to send an indication including the gesture detected by the gesture sensor;
a floor, attached to the bathroom structure, wherein the floor is adapted to support the weight of a human within the bathroom structure;
a human passage sensor adapted to detect human entry or exit through the door based on detecting hinge motion upon door opening or door closing, wherein the human passage sensor is configured to send an indication of human entry or exit through the door, and wherein the indication of human entry or exit through the door sent by the human passage sensor comprises the passage direction indicated as enter, or exit;
a human presence sensor adapted to detect the presence of a human within the bathroom structure, wherein the human presence sensor comprises a weight sensor configured in the floor, wherein the weight sensor is adapted to measure the weight supported by the floor, and wherein the human presence sensor is configured to send an indication of whether a human is present within the bathroom structure, based on the weight measured by the weight sensor;
one or more toilet, adapted with a computer-implemented toilet controller configured to flush the toilet in response to receiving a command to flush the toilet;
an autonomous floor-cleaning robot adapted with a computer implemented floor-cleaning robot controller configured to clean the floor in response to receiving a command to clean the floor;
at least one computer-implemented bathroom subsystem module configured to execute a bathroom cleaning process in response to receiving a bathroom cleaning process activation command; and,
a bathroom controller, comprising:
one or more processor;
a communication interface operably and communicatively coupling at least one processor of the one or more processor with the door lock, the door actuator, the outside human gesture sensor, the inside human gesture sensor, the human passage sensor, the human presence sensor, the one or more toilet, the autonomous floor-cleaning robot, and the at least one computer-implemented bathroom subsystem module;
a memory that is not a transitory propagating signal, the memory operably and communicatively coupled with the one or more processor and encoding computer readable instructions, including processor executable program instructions, the computer readable instructions accessible to the one or more processor, wherein the processor executable program instructions, when executed by the one or more processor, cause the one or more processor to perform operations comprising:
in response to receiving from the outside human hand gesture sensor an indication a user waved their hand in front of the outside human hand gesture sensor:
determine if a user remains in the bathroom, based on an indication received from the human presence sensor;
upon a determination no user remains in the bathroom:
determine if bathroom cleaning is in progress; and,
upon a determination bathroom cleaning is not in progress, unlock and open the door; and,
in response to receiving from the inside human hand gesture sensor an indication a user waved their hand in front of the inside human hand gesture sensor:
determine if the indication the user waved their hand is the first hand-wave indication received since unlocking the door;
in response to a determination the indication the user waved their hand is the first hand-wave indication received since unlocking the door:
close the door; and,
lock the door;
in response to a determination the indication the user waved their hand is not the first hand-wave indication received since unlocking the door:
unlock the door; and,
open the door;
in response to receiving from the human passage sensor an indication of human passage through the door, determine if a user exited the bathroom facility, based on the passage direction received from the human passage sensor;
in response to a determination a user exited the bathroom facility:
determine if a user remains in the bathroom, based on an indication received from the human presence sensor;
upon a determination no user remains in the bathroom, clean the bathroom, comprising:
send to the door actuator a command to close the bathroom door;
send to the door lock a command to lock the bathroom door;
send to at least one of the one or more toilet a command to flush the at least one of the one or more toilet;
send to the autonomous floor-cleaning robot a command to clean the floor; and,
in response to a determination bathroom cleaning is complete, send to the door lock a command to unlock the door; and,
a computer-implemented central hub communicatively and operably coupled with the bathroom controller, wherein the central hub is configured to receive usage, status, and consumable alert data from the bathroom controller.

11. The apparatus of claim 10, wherein the operations performed by the one or more bathroom controller processor further comprise send to the central hub usage, status, and consumable alert data collected by the one or more bathroom controller processor from at least one of the door lock, the door actuator, one or more toilet, and the floor-cleaning robot.

12. The apparatus of claim 10, wherein the apparatus further comprises a mobile device communicatively and operably coupled with the bathroom controller and the central hub, wherein the mobile device is configured with a mobile app adapted to control and monitor the bathroom and manage data accessible by the central hub.

13. The apparatus of claim 12, wherein the operations performed by the one or more bathroom controller processor further comprise: in response to receiving from the mobile app a PIN authorizing employee access to the bathroom, unlock the door; and, open the door.

14. The apparatus of claim 10, wherein the bathroom further comprises an outside display communicatively and operably coupled with the bathroom controller, wherein the outside display is visible outside the bathroom, and wherein the operations performed by the one or more bathroom controller processor in response to a determination bathroom cleaning is complete further comprise send to the outside display a command to show “vacant” as the bathroom status.

15. The apparatus of claim 10, wherein the floor-cleaning robot further comprises a sensor adapted to detect robot damage, and upon a determination by the floor-cleaning robot the floor-cleaning robot is damaged, the floor-cleaning robot stops cleaning and enters a safe mode.

16. The apparatus of claim 10, wherein the apparatus further comprises a cleaning robot storage compartment, and wherein the autonomous floor-cleaning robot stores itself in the storage compartment when the autonomous floor-cleaning robot finishes cleaning the floor.

17. An autonomous self-cleaning bathroom apparatus, comprising:
a substantially enclosed bathroom structure configured with a lockable door adapted to permit a human to enter and exit the bathroom structure through the door, wherein the lockable door includes a door lock operable to lock the door in response to receiving a command to lock the door, and wherein the door lock is operable to unlock the door in response to receiving a command to unlock the door;
a hinge, movably coupling the door with the bathroom structure to permit the door to open and close, wherein the hinge includes a door actuator configured to open the door in response to receiving a command to open the door, and wherein the door actuator is configured to close the door in response to receiving a command to close the door;
an outside human hand gesture sensor configured outside the bathroom structure, wherein the outside human hand gesture sensor is adapted to detect a human hand gesture outside the bathroom, and wherein the outside human hand gesture sensor is configured to send an indication including the gesture detected by the gesture sensor;
an inside human hand gesture sensor configured inside the bathroom structure, wherein the inside human hand gesture sensor is adapted to detect a human hand gesture inside the bathroom, and wherein the inside human hand gesture sensor is configured to send an indication including the gesture detected by the gesture sensor;
a floor, attached to the bathroom structure, wherein the floor is adapted to support the weight of a human within the bathroom structure;
a human passage sensor adapted to detect human entry or exit through the door based on detecting hinge motion upon door opening or door closing, wherein the human passage sensor is configured to send an indication of human entry or exit through the door, and wherein the indication of human entry or exit through the door sent by the human passage sensor comprises the passage direction indicated as one of: enter, or exit;
a human presence sensor adapted to detect the presence of a human within the bathroom structure, wherein the human presence sensor comprises a weight sensor configured in the floor, wherein the weight sensor is adapted to measure the weight supported by the floor, and wherein the human presence sensor is configured to send an indication of whether a human is present within the bathroom structure, based on the weight measured by the weight sensor;
one or more toilet, adapted with a computer-implemented toilet controller configured to flush the toilet in response to receiving a command to flush the toilet;
a cleaning robot storage compartment configured with a door adapted with an actuator, wherein the actuator is configured to open the cleaning robot storage compartment door in response to receiving a command to open the door, and wherein the actuator is configured to close the cleaning robot storage compartment door in response to receiving a command to close the door;
an autonomous floor-cleaning robot adapted with a computer implemented floor-cleaning robot controller configured to cause the robot to clean the floor in response to receiving a command to clean the floor, and wherein the autonomous floor-cleaning robot is configured to store itself in the cleaning robot storage compartment when the autonomous floor-cleaning robot finishes cleaning the floor;
a computer-implemented central hub configured to receive usage, status, and consumable alert data;
an outside display configured to display a message indicated by a command received by the display, wherein the outside display is visible outside the bathroom;
at least one computer-implemented bathroom subsystem module configured to execute a bathroom cleaning process in response to receiving a bathroom cleaning process activation command; and,
a bathroom controller, comprising:
one or more processor;
a communication interface operably and communicatively coupling at least one processor of the one or more processor with the door lock, the bathroom door actuator, the storage compartment door actuator, the outside human gesture sensor, the inside human gesture sensor, the human passage sensor, the human presence sensor, one or more toilet, the autonomous floor-cleaning robot, at least one computer-implemented bathroom subsystem module, the outside display, and the central hub;
a memory that is not a transitory propagating signal, the memory operably and communicatively coupled with the one or more processor and encoding computer readable instructions, including processor executable program instructions, the computer readable instructions accessible to the one or more processor, wherein the processor executable program instructions, when executed by the one or more processor, cause the one or more processor to perform operations comprising:
in response to receiving from the outside human hand gesture sensor an indication a user waved their hand in front of the outside human hand gesture sensor:
determine if a user remains in the bathroom, based on an indication received from the human presence sensor;
upon a determination no user remains in the bathroom:
determine if bathroom cleaning is in progress; and,
upon a determination bathroom cleaning is not in progress, unlock and open the door; and,
in response to receiving from the inside human hand gesture sensor an indication a user waved their hand in front of the inside human hand gesture sensor:
determine if the indication the user waved their hand is the first hand-wave indication received since unlocking the door;
in response to a determination the indication the user waved their hand is the first hand-wave indication received since unlocking the door:
close the door; and,
lock the door; and,
in response to a determination the indication the user waved their hand is not the first hand-wave indication received since unlocking the door:
unlock the door; and,
open the door; and,
in response to receiving from the human passage sensor an indication of human passage through the door, determine if a user exited the bathroom facility, based on the passage direction received from the human passage sensor;
in response to a determination a user exited the bathroom facility:
determine if a user remains in the bathroom, based on an indication received from the human presence sensor;
upon a determination no user remains in the bathroom, clean the bathroom, comprising:
send to the door actuator a command to close the bathroom door;
send to the door lock a command to lock the bathroom door;
send to at least one of the one or more toilet a command to flush the at least one of the one or more toilet;
send to the autonomous floor-cleaning robot a command to clean the floor; and,
in response to receiving a PIN authorizing employee access to the bathroom:
unlock the door; and,
open the door; and,
determine if bathroom cleaning is complete;
upon a determination bathroom cleaning is complete:
send to the door lock a command to unlock the door;
send to the outside display a command to show “vacant” as the bathroom status; and,
send to the central hub usage, status, and consumable alert data collected by the one or more bathroom controller processor from at least one of the door lock, the door actuator, one or more toilet, and the floor-cleaning robot; and,
a mobile device communicatively and operably coupled with the bathroom controller and the central hub, wherein the mobile device is configured with a mobile app adapted to control and monitor the bathroom and manage data accessible by the central hub.

18. The apparatus of claim 17, wherein the operations performed by the one or more bathroom controller processor upon a determination to initiate bathroom cleaning further comprise send to the cleaning robot storage compartment door actuator a command to open the storage compartment door; and wherein the operations performed by the one or more bathroom controller processor upon a determination bathroom cleaning is complete further comprise send to the cleaning robot storage compartment door actuator a command to close the storage compartment door.

19. The apparatus of claim 18, wherein the cleaning robot storage compartment further comprises a cleaning robot presence sensor adapted to detect the presence of the cleaning robot within the cleaning robot storage compartment, and wherein the cleaning robot presence sensor is configured to send to the bathroom controller an indication of whether or not the cleaning robot is present within the storage compartment.

20. The apparatus of claim 19, wherein the operations performed by the one or more bathroom controller processor upon a determination bathroom cleaning is complete further comprise: determine if the cleaning robot is present within the storage compartment, based on an indication received from the cleaning robot presence sensor; upon a determination the cleaning robot is present within the storage compartment, close the storage compartment door; and, upon a determination the cleaning robot is not present within the storage compartment after a predetermined period of time, send an alert to the bathroom controller comprising an indication the cleaning robot is not present within the storage compartment.
